(19) United States
(12) Patent Application Publication
(10) Pub. No.: US 2009/0210933 A1
(43) Pub. Date: Aug. 20, 2009

(54) System and Method for Online Content Production

(76) Inventors: Jeffrey A. Shear, Ardsley, NY (US); Mark Roboff, New York, NY (US); Dmitry Starosta, Brooklyn, NY (US); Iain Scholnick, Mill Valley, CA (US)

Correspondence Address: MCCARTER & ENGLISH, LLP NEWARK, FOUR GATEWAY CENTER, 100 MULBERRY STREET, NEWARK, NJ, 07102, US

(21) Appl. No.: 12/032,143

(22) Filed: Feb. 15, 2008

(51) Int. Cl. G06Q 30/00; H04L 9/32

(52) U.S. Cl. 726/6; 705/26

(57) ABSTRACT

A system and method for online content production is provided. Customized orders for content, such as a customized video to be used by a content requester (e.g., a business), can be created using a central website. The business can specify a location at which the content is to be produced, as well as desired shots to be included in the content. A plurality of content providers can register with the present invention to obtain assignments to produce content in response to the orders. The content provider creates the content at the location(s) specified in the order, including shots specified in the order. After the content has been produced, the content provider uploads the content to the central website, wherein the uploaded content is reviewed to determine whether it complies the specifications of the order. Content can be downloaded by the business, and payments for the content can be disbursed in accordance with pre-defined royalty distributions.

### BACKGROUND OF THE INVENTION

1. Field of the Invention

The present invention relates to a system and method for online content production and distribution.

2. Related Art

Digital content production represents a thriving industry. Many firms are devoted to producing and selling customized content in response to business requests for content. Examples of such content include customized videos relating to various aspects of businesses, including marketing videos and photography, product advertisements, commercials, promotional videos, and the like. Frequently, the produced content is multimedia in nature, including both video and audio.

Often, requests for content production are sent to production firms through telephone calls, facsimile, and e-mails, after a production firm has been contracted by the requesting party. Upon receiving requests, production firms dispatch personnel (e.g., freelance videographers or employees of the production firms) who are responsible for creating the content. In some cases, these personnel must travel to a designated location to capture the content (e.g., create a video at a designated location). When the content has been captured, editing of the content often occurs off-line, i.e., using customized computer systems and software owned by the production firms. The finalized content, whether in electronic or non-electronic form) is then sent to the requester, by mail, courier, or electronically.

What would be desirable, but has not yet been provided, is a system and method for online content production which allows businesses to create customized orders for content using a central website, allows content providers to retrieve orders from the central website and upload produced content in response to the orders, allows administrators to manage the content production process using the central website, and allows businesses to download produced content from the central website, using easy-to-navigate user interface screens.

### SUMMARY OF THE INVENTION

The present invention relates to a system and method for online content production. A central website allows a business to create a customized order for content, such as a customized video to be used by the business. The business can specify a location at which the content is to be produced, as well as desired shots to be included in the content. Other aspects of the content can also be specified in the order, such as a desired computer file format, image size, aspect ratio, resolution (e.g., high-definition video), and other aspects of the content. A plurality of content providers (e.g., freelance videographers) can register with the present invention to obtain assignments to produce content in response to the orders. The assignments specify production aspects in accordance with the orders. The content provider creates the content at the location(s) specified in the order, including shots specified in the order.

After the content has been produced, the content provider uploads the content to the central website, wherein the uploaded content is reviewed to determine whether it complies with the specifications of the order. A three-stage review can be carried out, wherein in a first stage, the present invention automatically checks the uploaded content to ascertain whether it contains any deficiencies. If acceptable, the content can be transferred in a second stage to an administrator for his or her review. A third-stage review can then be conducted by the business requesting the content. Deficiencies can be remedied by the original content provider, or a newly-assigned content provider. Completed and satisfactory content can be downloaded by the business, and payments for the content can be handled by the present invention and disbursed in accordance with pre-defined royalty distributions.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing sample computer hardware components utilized to implement the present invention;

FIG. 2 is a flowchart showing processing steps according to the present invention for registering users;

FIGS. 3A-3G are screenshots of user interface screens generated by the present invention for registering users;

FIG. 4 is a flowchart showing processing steps according to the present invention for allowing a user to create new orders for content and to specify production attributes for the content;

FIGS. 5A-5L are screenshots of user interface screens generated by the present invention for creating new orders for content and specifying production attributes for the content;

FIGS. 6A-6B are flowcharts showing processing steps according to the present invention for managing production assignments and creating notes regarding orders for content;

FIGS. 7A-7C are screenshots of user interface screens generated by the present invention for managing production assignments and creating notes regarding orders for content;

FIG. 8 is a flowchart showing processing steps according to the present invention for allowing content providers review, select, and accept production assignments;

FIGS. 9A-9O are screenshots of user interface screens generated by the present invention for reviewing, selecting, and accepting production assignments;

FIG. 10 is a flowchart showing processing steps according to the present invention for allowing content providers to upload content for a production assignment and to manage uploaded content;

FIGS. 11A-11P are screenshots showing user interface screens generated by the present invention for uploading content and managing uploaded content;

FIG. 12 is a flowchart showing processing steps according to the present invention for allowing administrators to review content uploaded by a content provider and for allowing a user to download content produced in response to the user's order;

FIGS. 13A-13J are screenshots showing user interface screens generated by the present invention for reviewing uploaded content and downloading content;

FIGS. 14A-14C are flowcharts showing processing steps according to the present invention for allowing administrators to create angle and direction notes for customized orders, manage packages of content, and manage payment batches;

FIGS. 15A-15J are screenshots of user interface screens generated by the present invention for creating angle/direction notes, managing packages of content, and managing payment batches;

FIG. 16 is a flowchart showing processing steps according to the present invention for elevating user statuses, managing user contracts, and processing user surveys;

FIGS. 17A-17N are screenshots of user interface screens generated by the present invention for elevating user statuses, managing user contracts, and processing user surveys;

FIG. 18 is a flowchart showing processing steps according to the present invention for managing user accounts, addresses, and profiles; and

FIGS. 19A-19I are screenshots showing user interface screens generated by the present invention for managing user accounts, addresses, and profiles.

### DETAILED DESCRIPTION OF THE INVENTION

The present invention relates to a system and method for online content production. Customized order for content, such as a customized video to be used by a business, can be created using a central website. The business can specify a location at which the content is to be produced, as well as desired shots to be included in the content. By the term “shot,” it is meant a specific picture, series of pictures, video sequence, and/or collection of video sequences requested by a business in an order for content. A plurality of content providers can register with the present invention to obtain assignments to produce content in response to the orders. The content provider creates the content at the location(s) specified in the order, including shots specified in the order. After the content has been produced, the content provider uploads the content to the central website, wherein the uploaded content is reviewed to determine whether it complies the specifications of the order. Content can be downloaded by the business, and payments for the content can be handled by the present invention and disbursed in accordance with pre-defined royalty distributions.

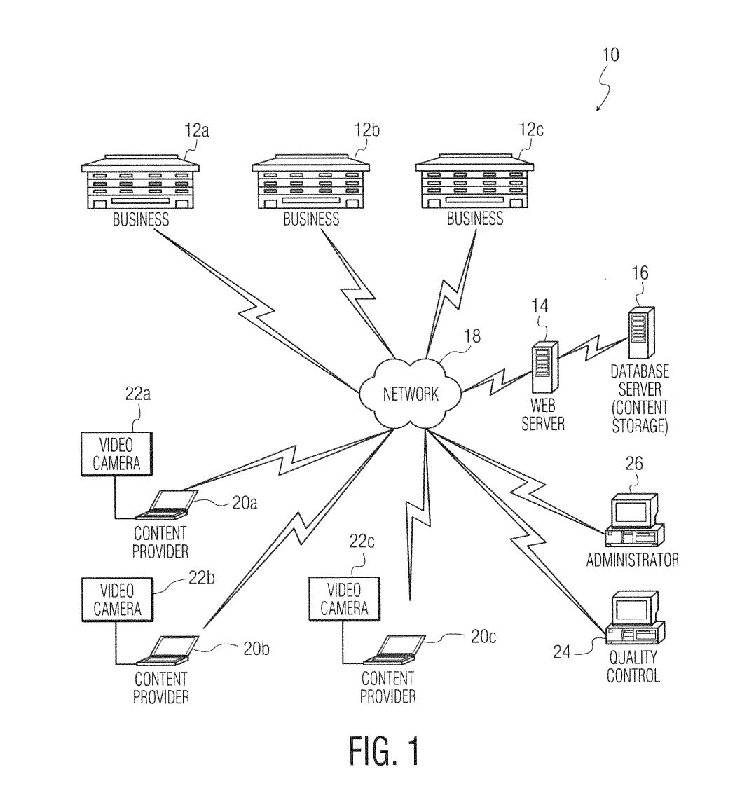

FIG. 1 is a diagram showing the system 10 of the present invention. The system 10 allows one or more businesses 12a-12c, to specify and order desired content, including advertising videos about a business, videos relating to specific business endeavors (e.g., project-related videos, etc.), or any other desired type of video. Orders and specifications for desired content can be provided by the businesses 12a-12c using a web-based application hosted by a web server 14 and accessible via a network 18, such as the Internet. The web server 14 is in communication with a database server 16, which stores orders for content provided by the businesses 12a-12c, as well as produced content. It is noted that the businesses 12a-12c could also comprise individuals, educational institutions, or any person or entity interested in ordering content. The web server 14 and the database server 16 are programmed in accordance with the present invention to provide the services and features disclosed herein, as well as coordination, management, and communication functions.

One or more content providers 20a-20c (e.g., videographers, photographers, etc.) can access the system 10 of the present invention, and can retrieve orders for content stored in the database server 16. Each of the content providers 20a-20c could include equipment for recording a video in accordance with a businesses' order and its associated specifications, such as a location at which the video is to be recorded, media type, and other parameters as will be discussed herein in greater detail below. Optionally, the content providers 20a-20c could have video cameras 22a-22c for digitally recording videos, and computers in communication with the network 18 for transmitting recorded videos to the web server 14 for uploading to and storage in the database server 16. Such cameras could include professional grade and/or high-definition equipment, as well as consumer-grade equipment, for capturing videos and/or still images. Also, still digital cameras could be utilized for capturing still images. Indeed, the present invention could be used to process and manage orders for still images, and for uploading still image content. Such images could be provided by a professional photographer in response to an order for content specified by a business, and uploaded by the photographer to the present invention for review and retrieval by the business.

When content, such as a video, has been recorded and uploaded to the database server 16, it can be reviewed by a quality control personnel 24 having a computer system in communication with the web server 14 and the database server 16, to ensure that the content meets the specifications defined by a business. A three-stage review can be carried out, wherein in a first stage, the present invention automatically checks the uploaded content to ascertain whether it contains any deficiencies. If acceptable, the content can be transferred in a second stage to an administrator (e.g., the administrator 26) for his or her review. A third-stage review can then be conducted by one the businesses 12a-12c associated with a particular order. Deficiencies can be remedied by an original content provider, or a newly-assigned content provider. The system 10 of the present invention could also include the ability to automatically review uploaded videos, compare attributes of the uploaded videos to a business's specifications, and to automatically determine any deficiencies in the uploaded videos and communicate same to the videographers 20a-20c. It is noted that the present invention is not limited to the production of videos, and that orders for any desired type of content, including audio, video, and textual content (e.g., printed advertisements, publications, etc.), can be processed by the present invention.

When uploaded content has been approved, it is ready to be downloaded by one or more of the businesses 12a-12c. The content can be downloaded to a business using the network 18 (e.g., over the Internet), using Hypertext Transfer Protocol (HTTP) or File Transfer Protocol (FTP). The system 10 of the present invention thus allows for on-demand, online content production for a business. For example, using the present invention, a business could request that a video be produced showing the exterior of one of the business's buildings in a city, that the video has a duration of 2 minutes, and that the video be recorded in MPEG-2 or MPEG-4H.265 format. The order could also specify other aspects of the video production that are desired, such as lighting, etc. Once the order has been submitted and stored in the database server 16, a videographer can download the order, travel to the location specified in the order, record the video in accordance with the order, and upload the recorded video to the database server 16, for subsequent downloading by a business. It is noted that one or more administrators (and associated computers) could be provided for administration of the system 10 as will be discussed herein. The web server 14 and the database server 16 could be any suitable computer servers (e.g., servers having one or more microprocessors compatible with an x86 or x64 code base, such as INTEL and AMD microprocessors) running any suitable operating systems (e.g., MICROSOFT WINDOWS Server, etc.) and associated web hosting and database support applications (e.g., MICROSOFT SQL Server relational database management system, etc.). The servers 14 and 16 are programmed in accordance with the present invention to provide the online, on-demand content production services disclosed herein. Computers associated with the businesses 12a-12c and the videographers 20a-20c could include any suitable desktop, laptop, portable or server computing hardware.

A high-level description of the processing steps implemented by the present invention, which will be further described in detail below, is as follows:

1. A business creates an order for content;

2. A content provider accepts the order;

3. The content provider creates and edits the content;

4. The content provider uploads the content to the present invention;

5. The content provider assigns pieces of content (e.g., files) to shots defined in the order;

6. The content provider sends the fulfilled order to an administrator for review;

7. The administrator reviews the fulfilled order to determine if it complies with the business' specifications, and if so, sends the fulfilled order to the business for review; and

8. The business reviews the fulfilled order, and if it complies with the specifications, accepts delivery by downloading the content.

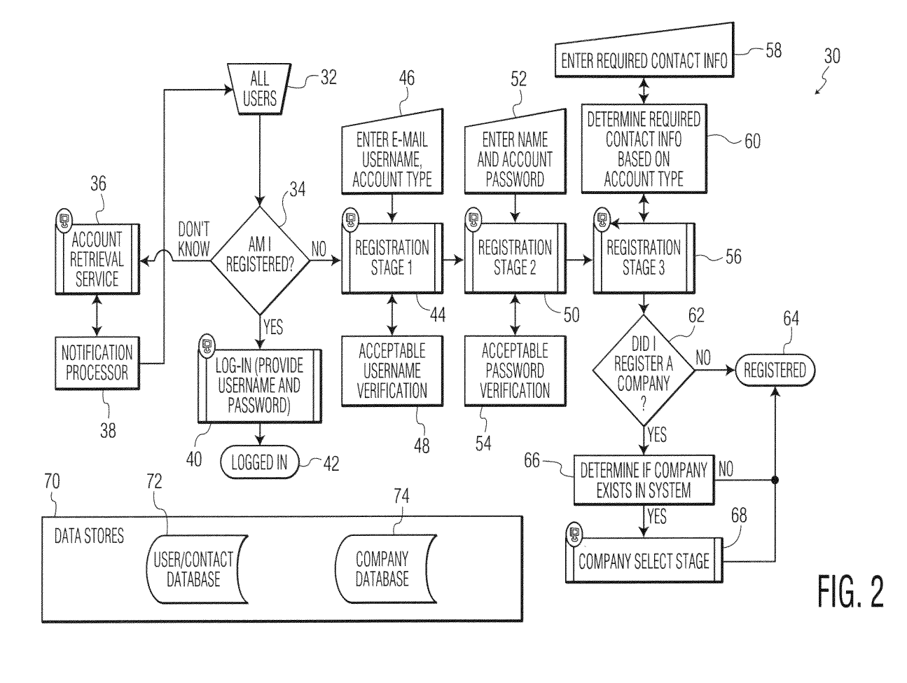

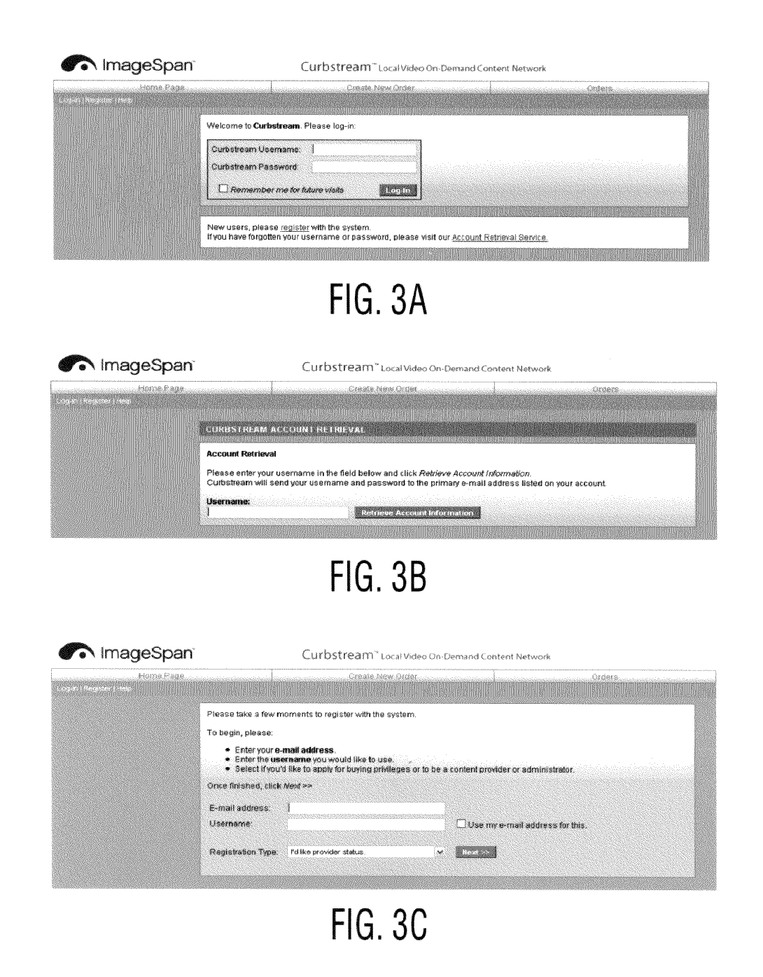

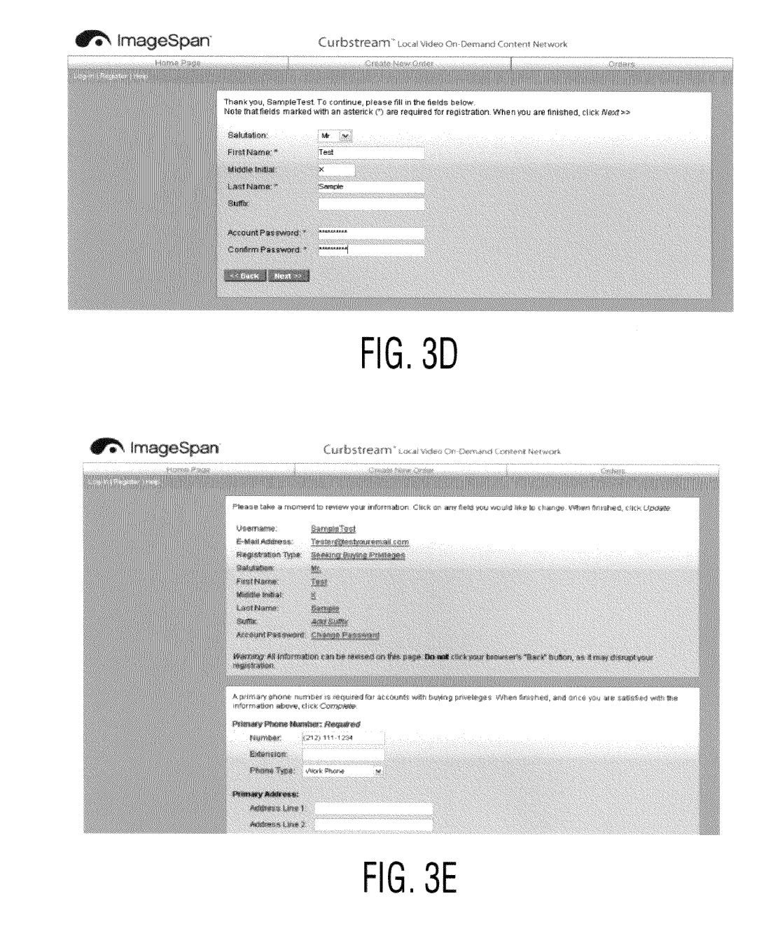

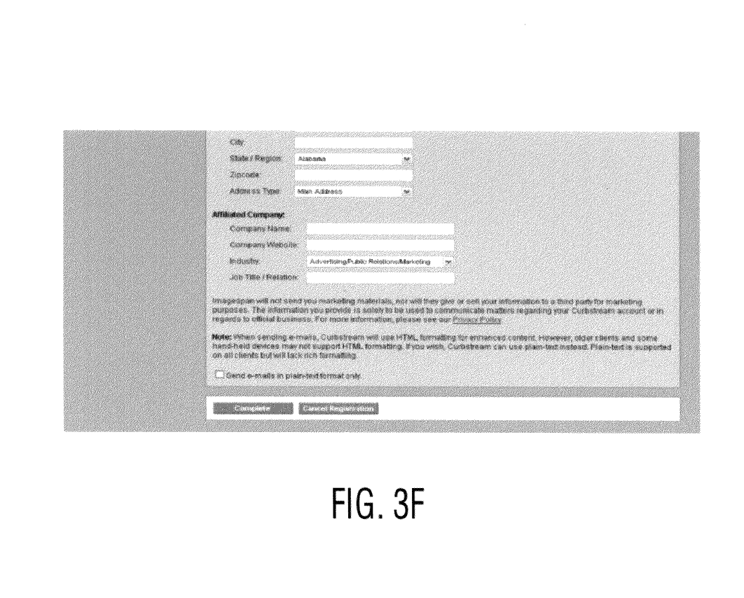

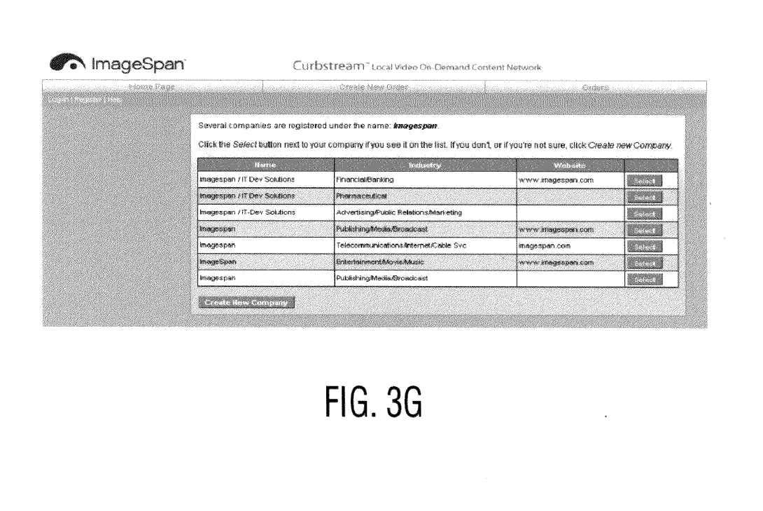

Referring now to FIGS. 2 and 3A-3G, FIG. 2 is a flowchart, indicated generally at 30, showing processing steps in accordance with the present invention for allowing users to log into the present invention, and for registering users. All users, indicated at 32, such as the businesses 12a-12c and the content providers 20a-20c of FIG. 1, determine in step 34 whether they are registered with the system of the present invention. If the user does not know whether he or she is registered, or if the user has forgotten his or her password, step 36 occurs, wherein an account retrieval service 36 is initiated. This service is illustrated in the screenshot of FIG. 3B, wherein it can be seen that a user is prompted to provide a user name to retrieve an account. After this information is provided, a notification processor is executed in step 38 to notify the user whether the specified account exists and, if so, to inform the user of his or her user name and password. If the user determines in step 34 that he or she is registered, step 40 occurs, wherein the user is prompted to log in by providing a user name and password. This is illustrated in the screenshot of FIG. 3A.

If the user knows in step 34 that he or she is not registered, a first registration stage occurs in step 44, wherein the user is prompted to provide an e-mail address, a user name, and account type information 46. This is illustrated in the screenshot of FIG. 3C. In step 48, the provided user name is processed to determine whether it is acceptable (e.g., whether there are any other individuals with the same user name), and if not acceptable, the user is prompted to provide a new user name. After the user name has been verified, step 50 occurs, wherein the user is prompted to enter information 52 relating to the user's name and account password. This is illustrated in the screenshot of FIG. 3D. In step 54, the password is processed to determine whether it is acceptable (e.g., whether it complies with one or more pre-defined password rules), F and if not acceptable, the user is prompted to provide a new password.

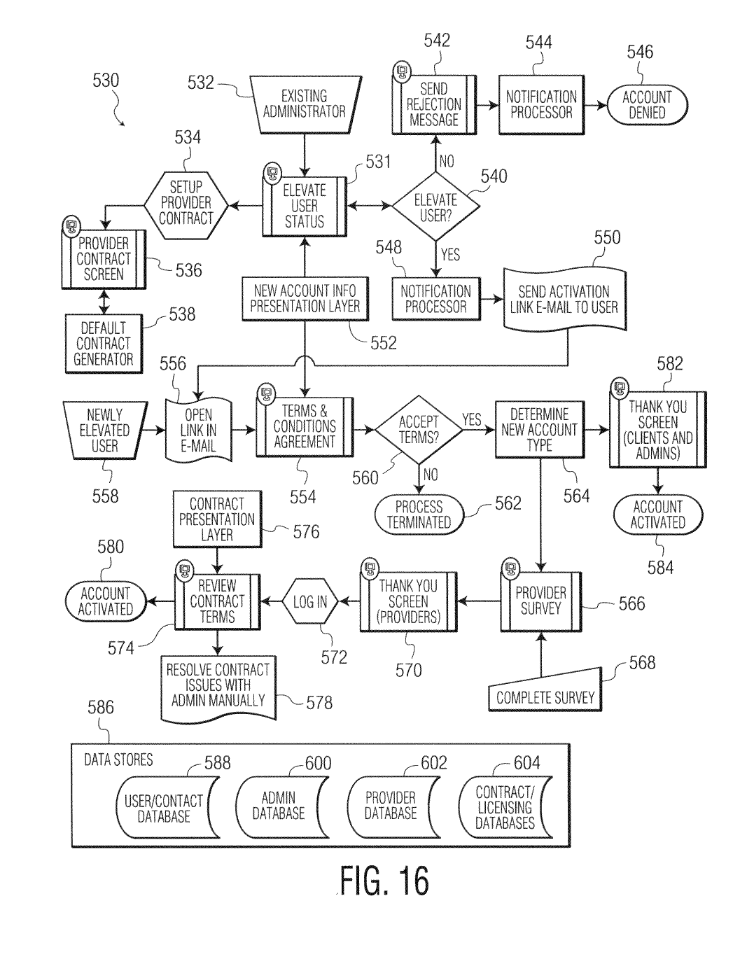

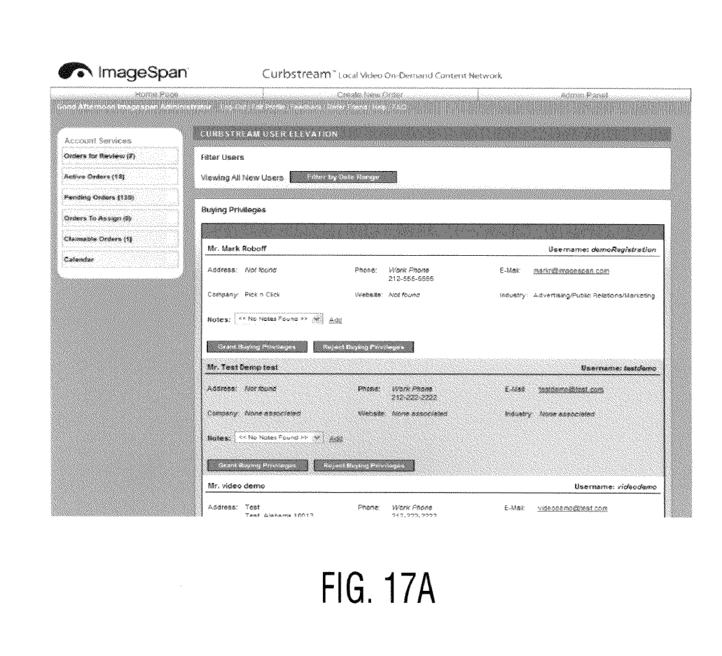

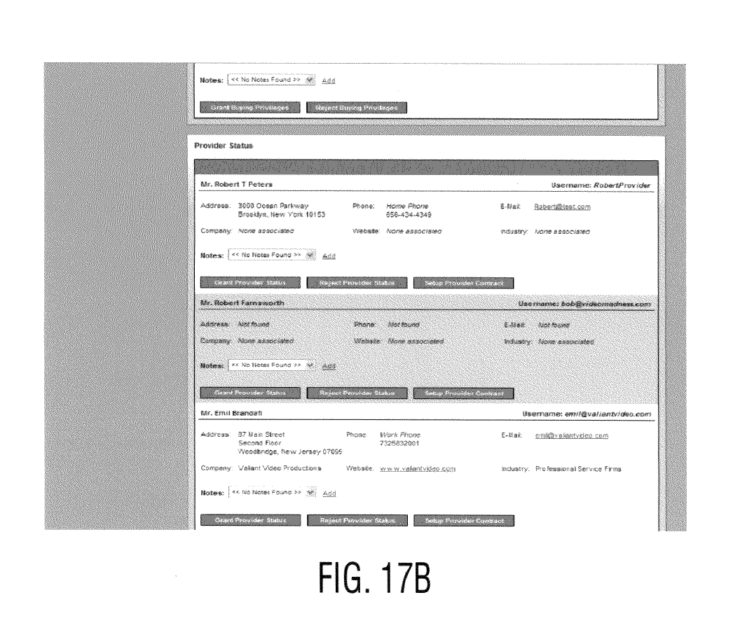

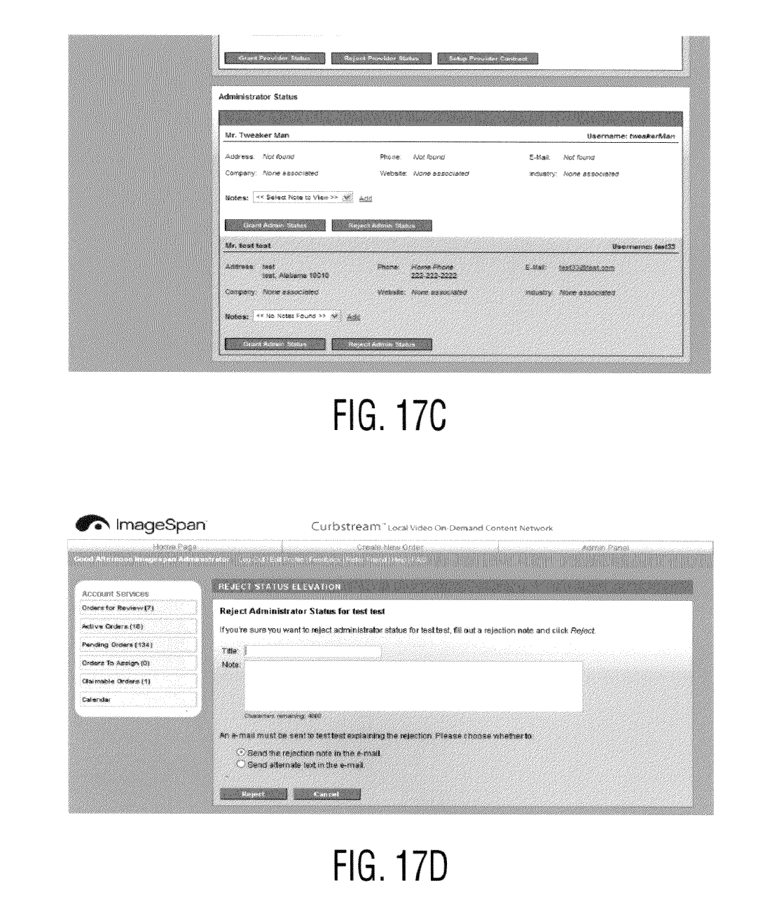

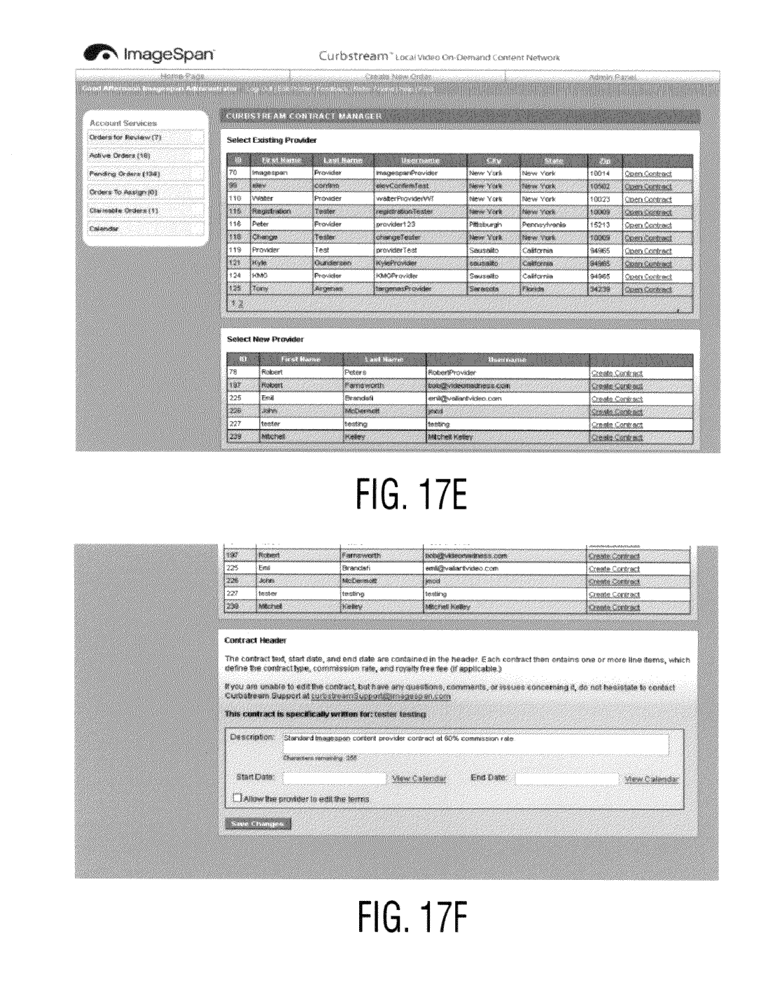

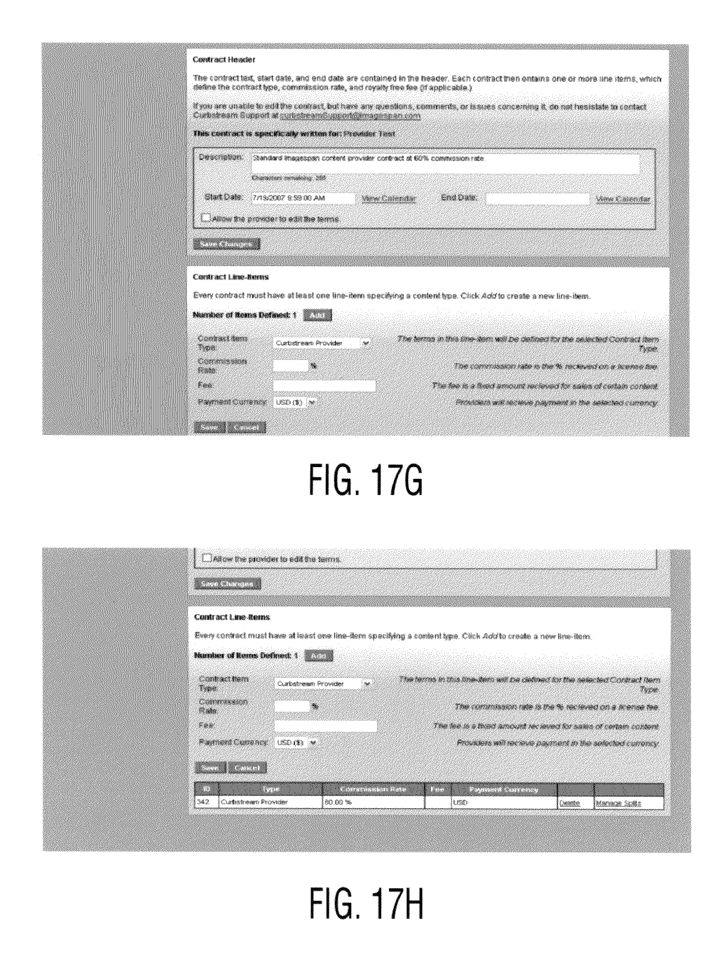

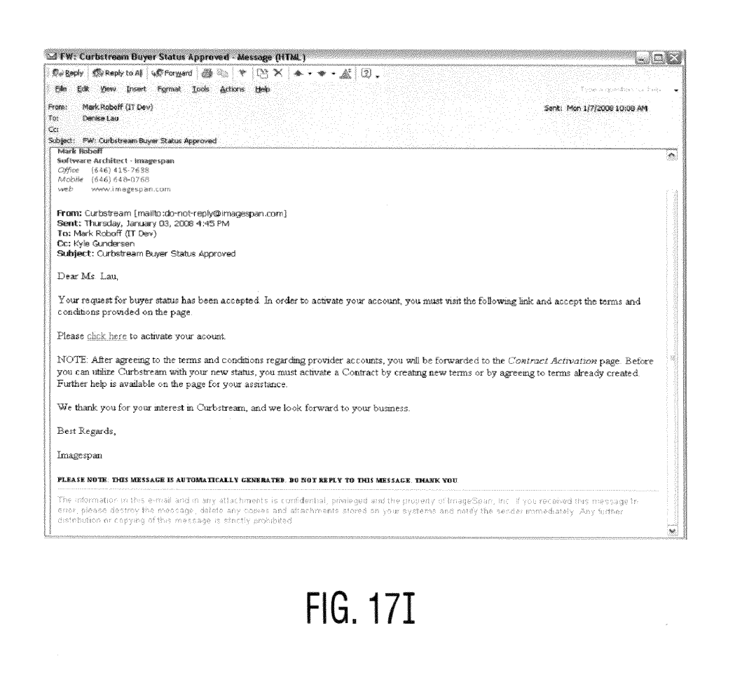

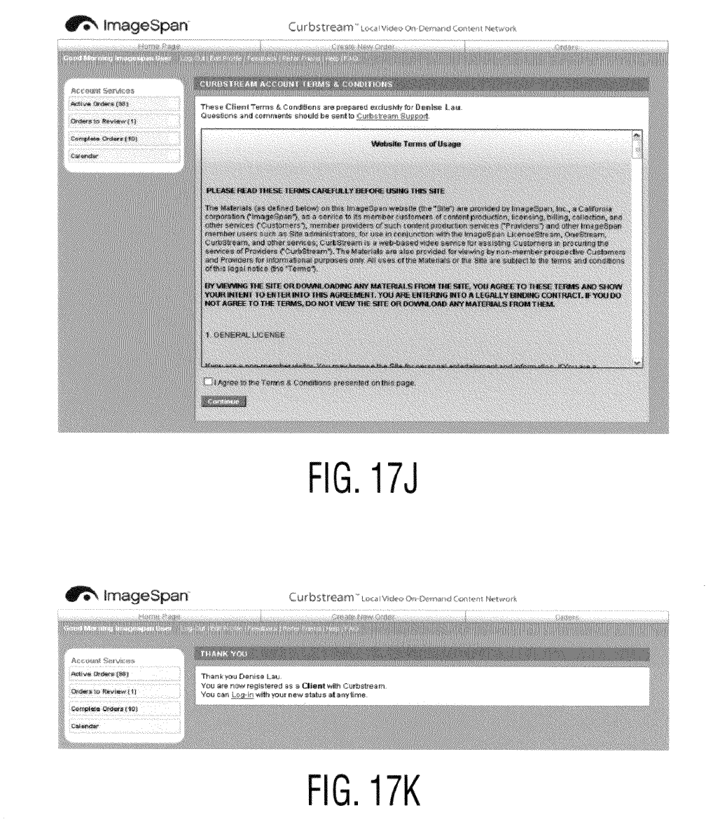

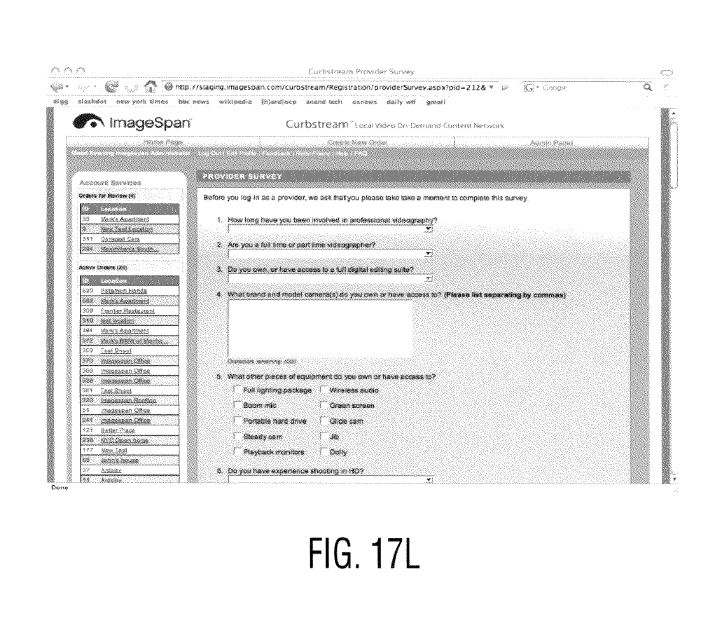

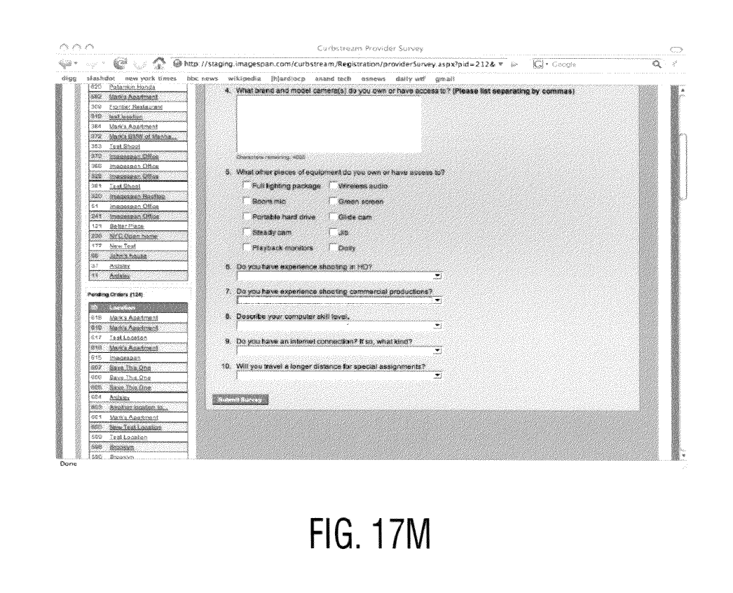

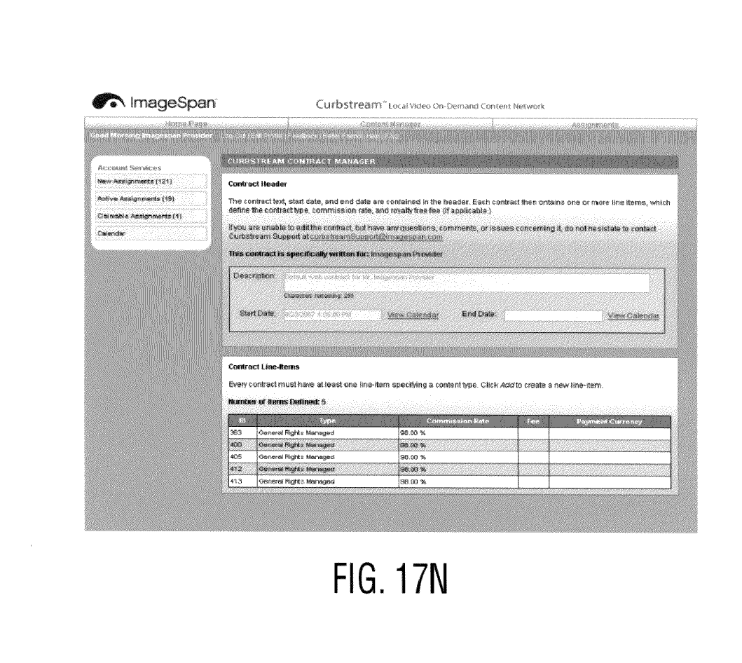

In step 56, a final registration step occurs, wherein in step 60, required contact information is determined based upon the account type specified by the user. The required contact information 58 is then requested from the user, as illustrated in the screenshot in FIGS. 3E-3F. Such information could include, but is not limited to, primary phone number, primary address, and affiliated company information, if any. Optionally, the user could be asked whether to receive e-mails generated by the present invention in either text or hypertext markup language (HTML) format. In step 62, a determination is made as to whether the user registered information about a company. If so, step 66 occurs, wherein a determination is made as to whether a matching company exists in the system. If a negative determination is made, step 64 occurs, wherein registration of the user is complete. Otherwise, if a positive determination is made, step 68 occurs, wherein the user is provided with a list of companies and to select a matching company, as illustrated in the screenshot of FIG. 3G. Once the company has been selected, step 64 occurs, wherein registration of the user is complete. The information acquired by the steps illustrated in FIG. 2 can be stored in data stores 70, which could include a user contact database 72 and a company database 74. To provided additional security, access to the present invention by a user may only be permitted if the registration information provided by the user has been reviewed and approved by an administrator, as discussed below in connection with FIGS. 16 and 17A-17N.

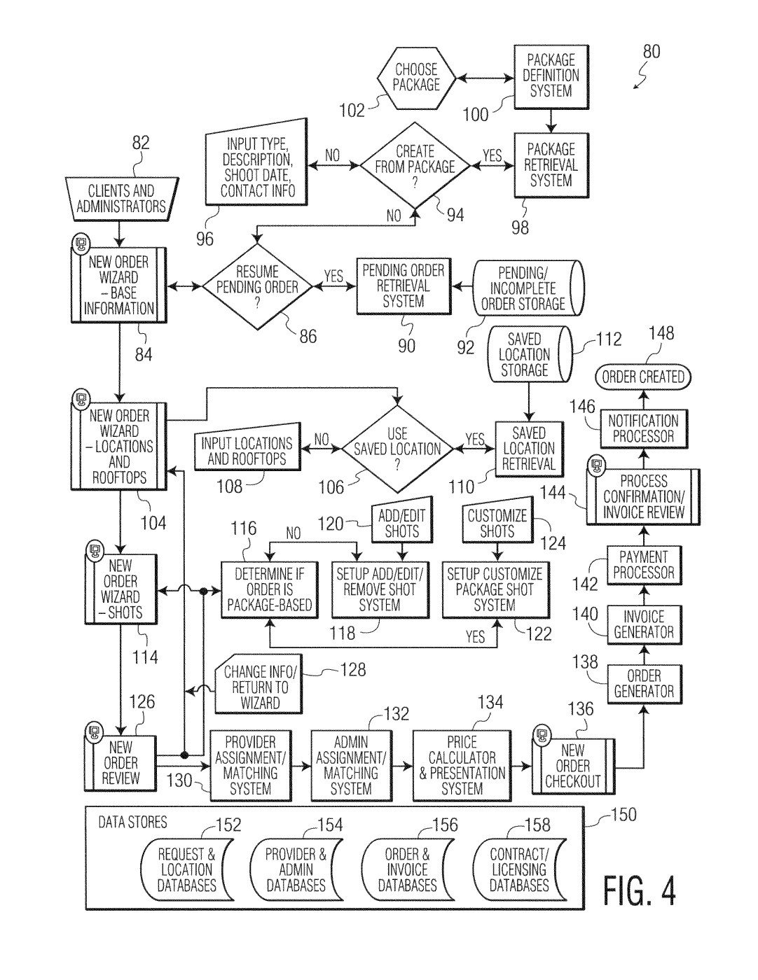

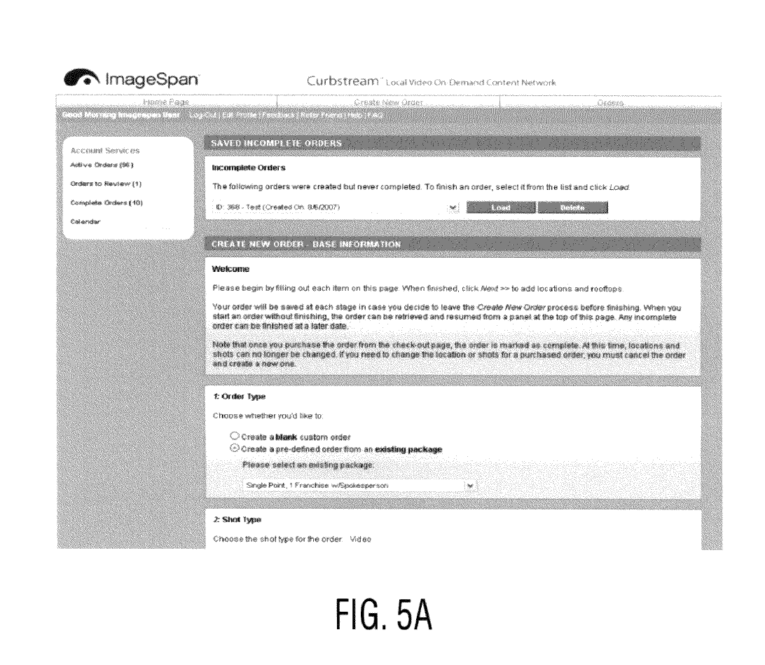

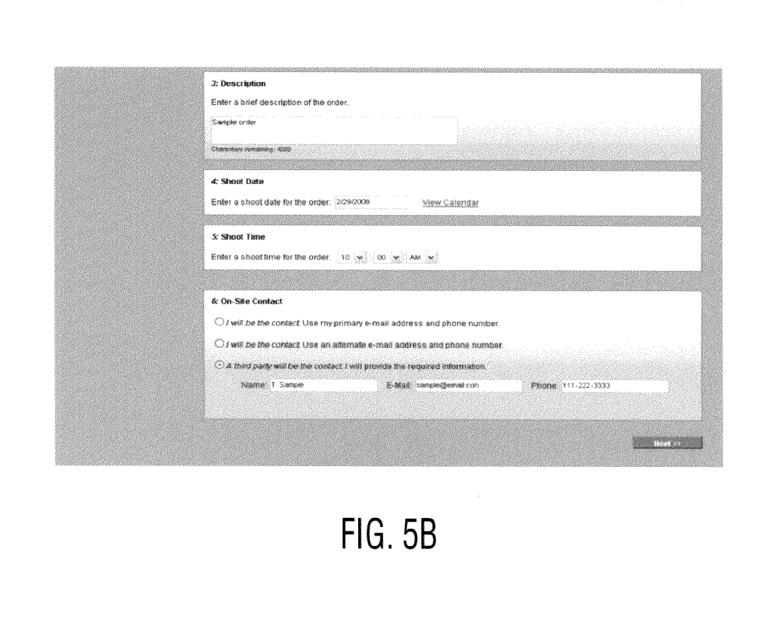

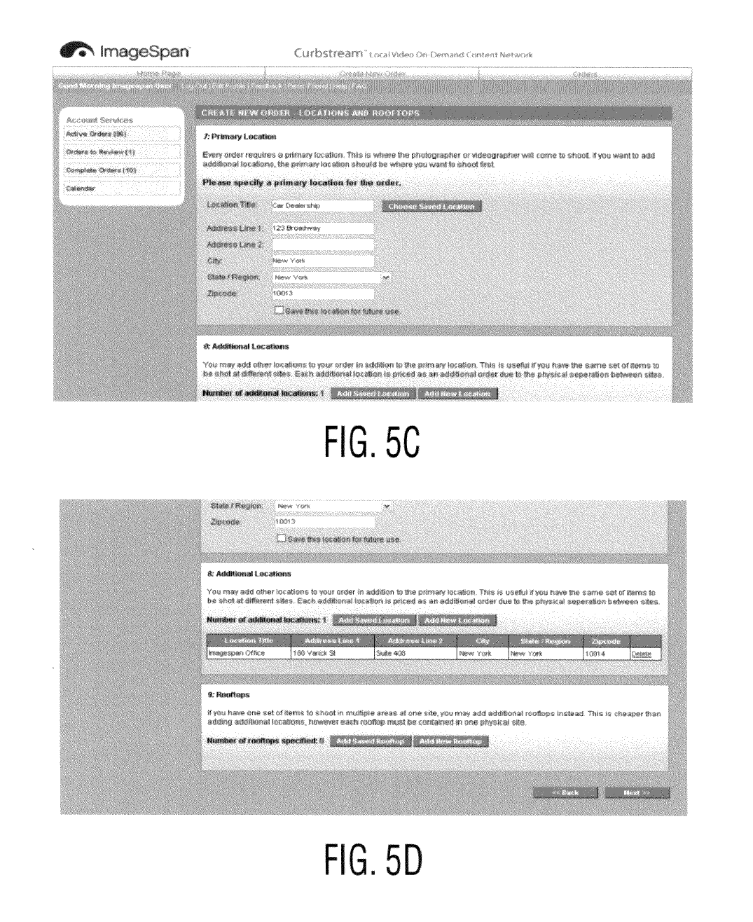

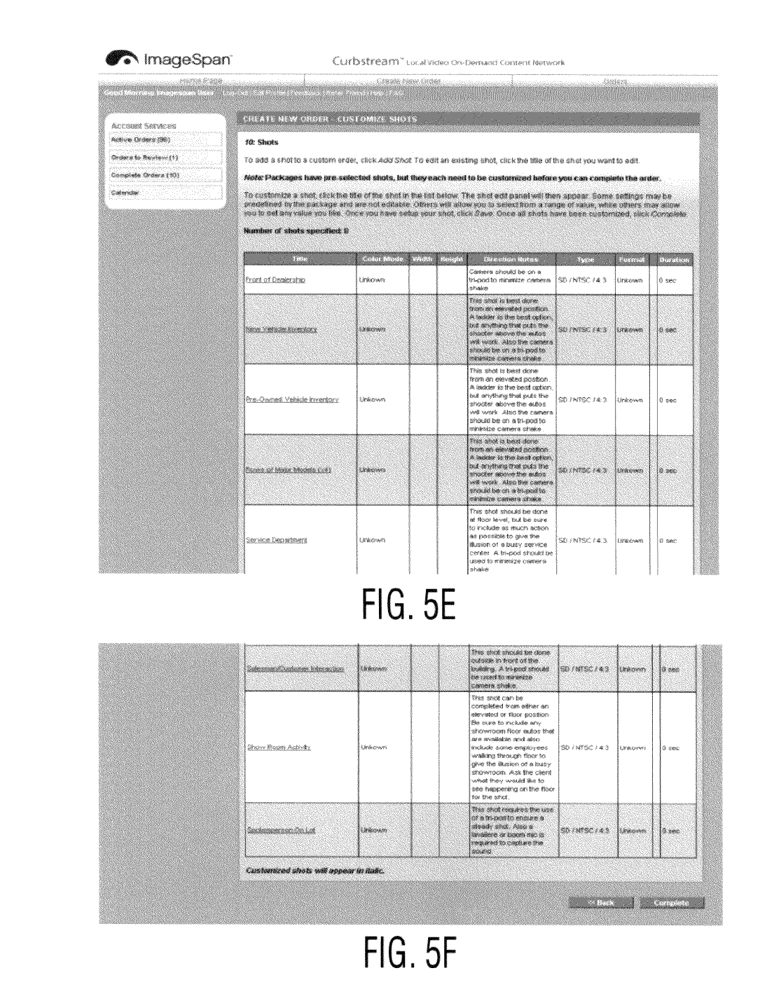

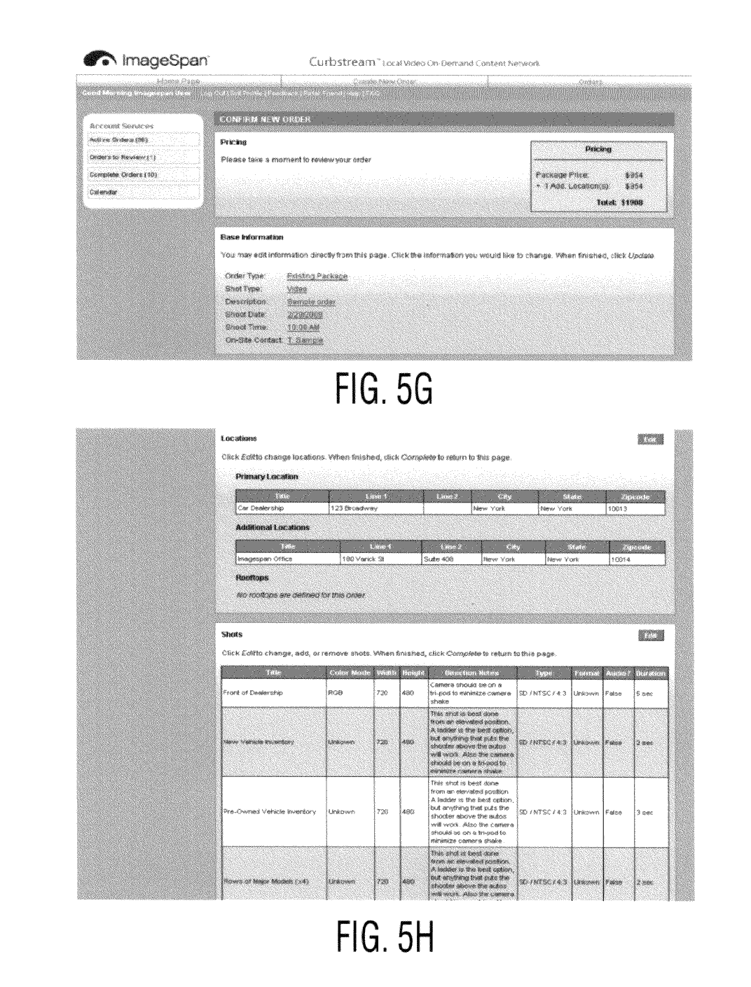

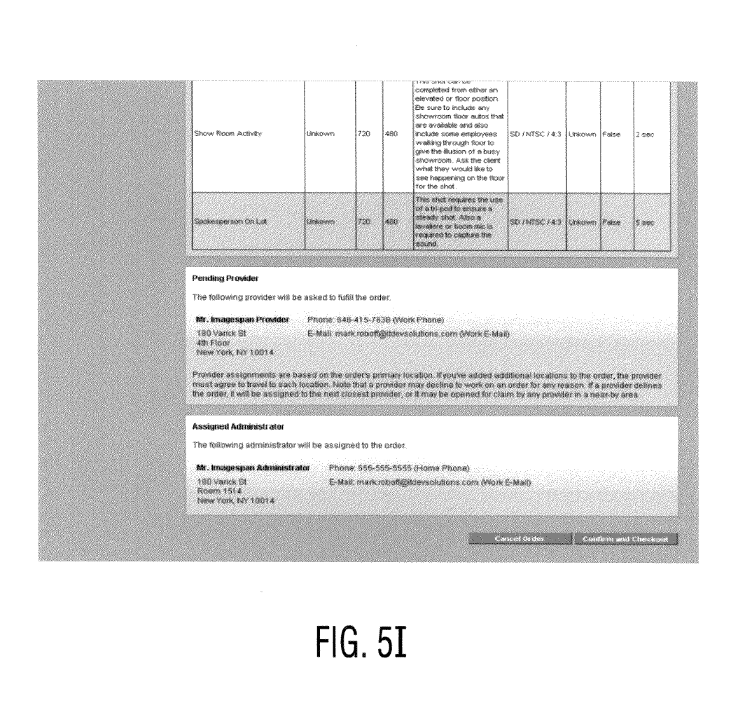

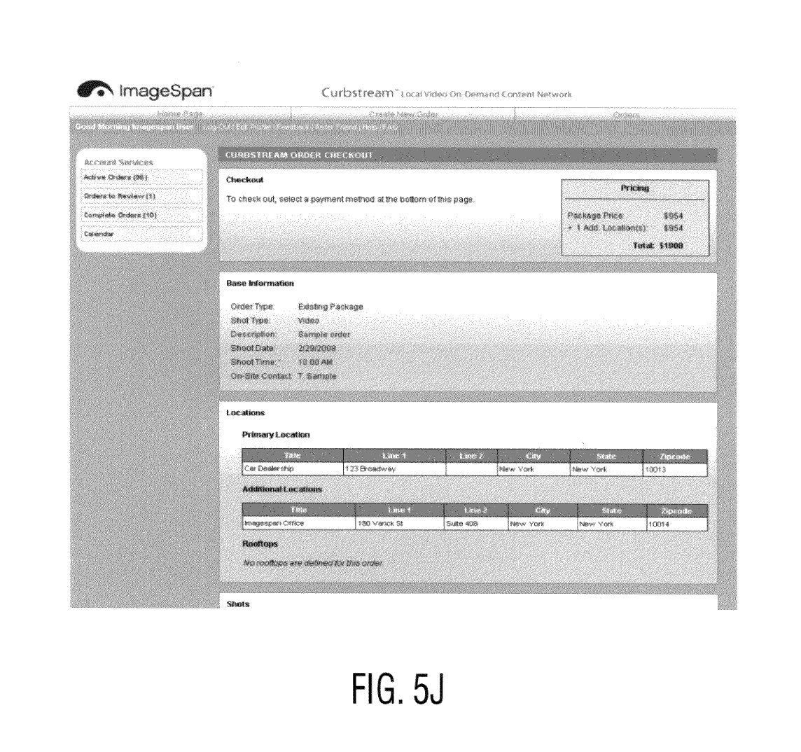

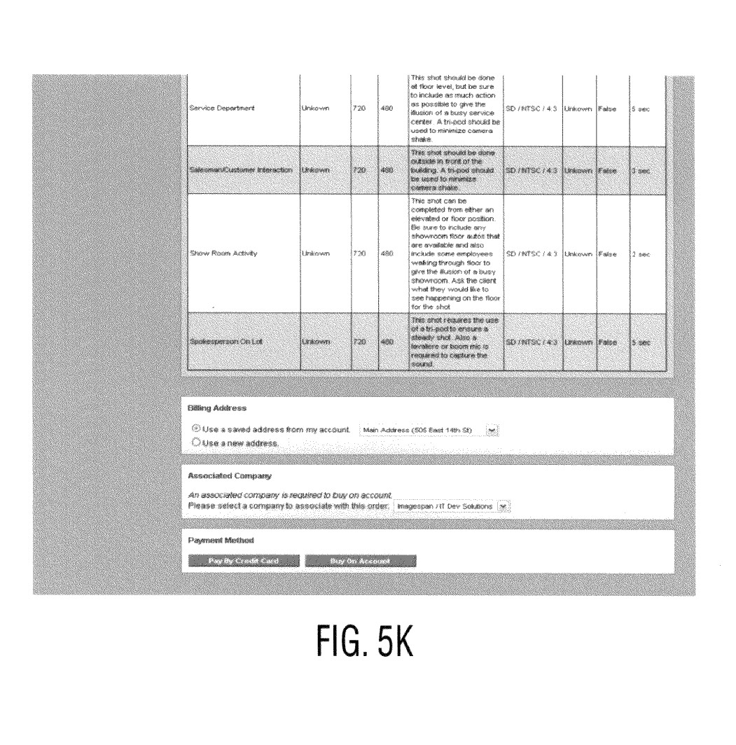

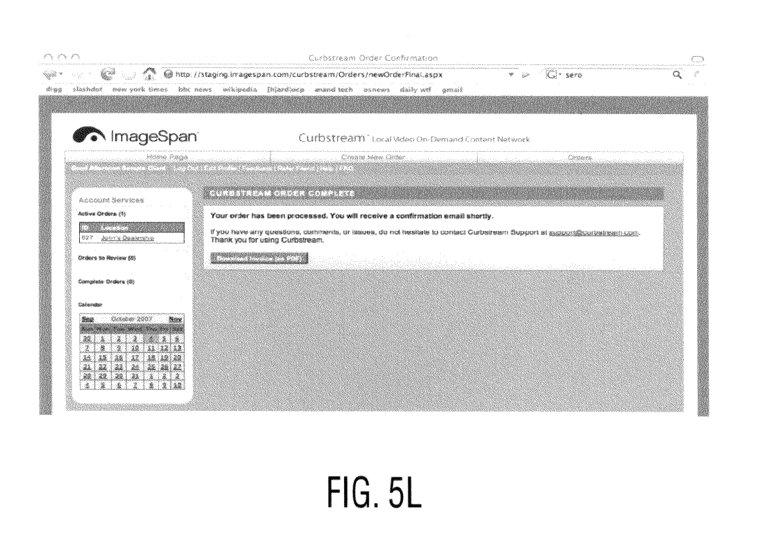

Referring to FIGS. 4 and 5A-5L, FIG. 4 is a flowchart showing processing steps according to the present invention, indicated generally at 80, for allowing a business to place an order for content production, and for processing such orders. In step 84, a client and/or administrator 82 (e.g., one or more of the businesses 12a-12c of FIG. 1, and/or the administrator 26 of FIG. 1) is provided with a plurality of screens which provide the client an online “wizard” for allowing the client to create an order for content production. These screens are shown in the screenshots of FIGS. 5A-5B. In step 86, the user is queried by the wizard to determine whether the user wishes to resume a pending order (i.e., the user previously began the process for ordering a video production, but the order was interrupted or saved). If a positive determination is made by the user, step 90 occurs, wherein a pending order retrieval process is initiated to locate the pending order from a pending/incomplete order database 92. If a negative determination is made, step 94 is invoked.

In step 94, the user determines whether he or she wishes to create the order using a pre-defined order package. Such a package could include pre-defined order attributes which could optionally be changed by the user. If a positive determination is made, step 98 occurs, wherein a package retrieval system process is invoked. This process interacts with a package definition system process in step 100, and in step 102, the user is provided with the option to choose a desired package. If a negative determination is made in step 94, step 96 occurs, wherein the user provides information about the type of desired content (e.g., a video), a description of the content, and contact information. As shown in the screenshots of FIGS. 5A-5B, the user can also specify a desired shooting date and a shooting time for a video. Contact information for a business could be by way of e-mail and/or telephone. Additionally, contact information for the business could be automatically provided from the business' account registration information. The contact information can specify a “liaison” who will meet a content provider at the designated location and time of a shooting session. When all required information has been supplied by the user, processing proceeds to step 104.

In step 104, the user is provided with wizard screens, as shown in FIGS. 5C-5D, which allow the user to provide detailed information about the location where the content is to be produced, as well as shooting locations. Rooftops where videos should be taken could be specified. By the term “rooftop,” it is meant a specific location or building within a larger complex, such as a building corresponding to a HONDA car dealership located within a larger car dealership complex (where, for example, the larger car dealership could also be selling SUBARU and other brands of cars). In step 106, the user decides whether to utilize a description of a location that was previously provided to the present invention. If so, step 110 occurs, wherein the stored location is retrieved from a saved location database 112. Otherwise, step 108 occurs, wherein the user inputs detailed information about shooting locations and rooftops (if desired). As shown in FIGS. 5C-5D, the detailed information could include location address and title, identification of additional locations where the video should be taken, and addresses of buildings where rooftop video shots are desired. For example, a business in Manhattan, N.Y. could utilize the present invention to request that a 5-minute promotional video about the business be made at a desired date and time, and that the video includes footage showing the facade of the building as well as footage of the city taken from the rooftop of the building. When all required information has been supplied, processing proceeds to step 114.

In step 114, the user is provided with wizard screens, as shown in FIGS. 5E-5F, which allow the user to specify desired shots for the content. In step 116, the present invention processes the order to determine whether the order is a package-based order (e.g., if the order is part of a group of orders). If a negative determination is made, steps 118-120 occur, wherein the user can add, edit, or remove shots. Information about shots could include, but is not limited to, shot title, color mode, width and height (e.g., in pixels), direction notes, video type (e.g., NTSC video standard, with a 4:3 aspect ratio), file format, indication as to whether audio is to be included, and duration. If a positive determination is made in step 116, steps 122-124 occur, wherein customized shots 124 defined by a package are determined and set up.

In step 126, the user is provided with a plurality of screens, shown in FIGS. 5G-5I, wherein the user can review an order and make any necessary changes. If any changes are necessary, in step 128, one or more of the steps described above can be invoked as necessary to allow the user to update information. When an order has been reviewed by the user, step 130 occurs, wherein the order is assigned to a content provider, such as one of the content providers 20a-20c of FIG. 1 (e.g., a videographer). Then, in step 132, an administrator, such as the administrator 26 of FIG. 1, is assigned to the order. In step 134, the present invention calculates a price for the order, which is presented to the user in a screen. Such a calculation could be made by analyzing a pre-defined set of business rules to determine a suitable price. Optionally, package prices could be set by a package definition. In step 136, the user is provided with a plurality of screens, shown in FIGS. 5J-5K, wherein the order is “checked out” by the user. In steps 138-142, order and invoice generation processes are invoked, and a payment processor is initiated. In step 144, the user is provided with a confirmation/invoice review screen, as shown in FIG. 5L. In step 146, a notification processor is initiated, wherein notification of the new order is provided to a content provider (e.g., one or more of the content providers 20a-20c of FIG. 1) and an assigned administrator (e.g., the administrator 26 of FIG. 1). Additionally, a confirmation e-mail, containing information about the order, is sent to the business requesting the order. In step 148, the order has been created, and processing is completed. It is noted that the information processed by the steps of FIG. 4 could be stored in data stores 150, which could include a request and location database 152, a provider and administrator database 154, an order and invoice database 156, and a contract/licensing database 158.

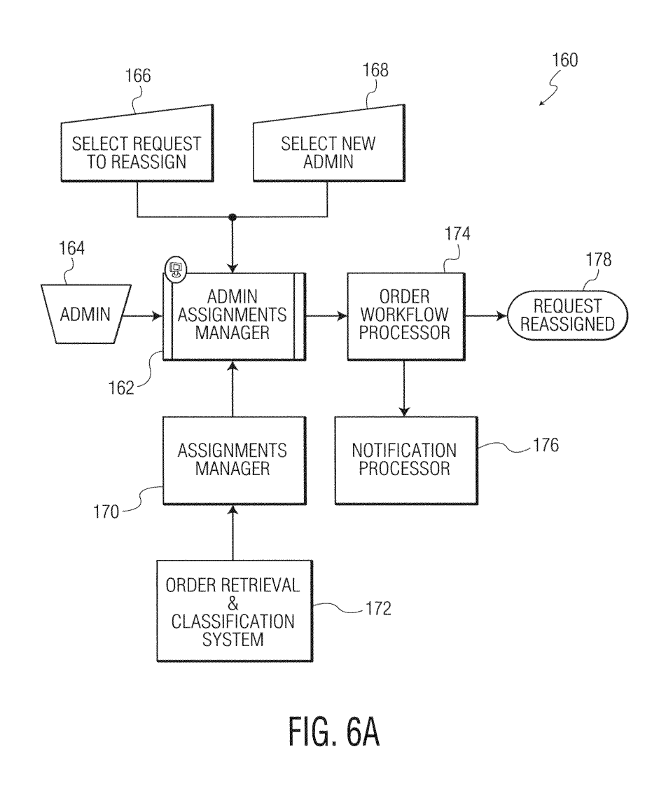

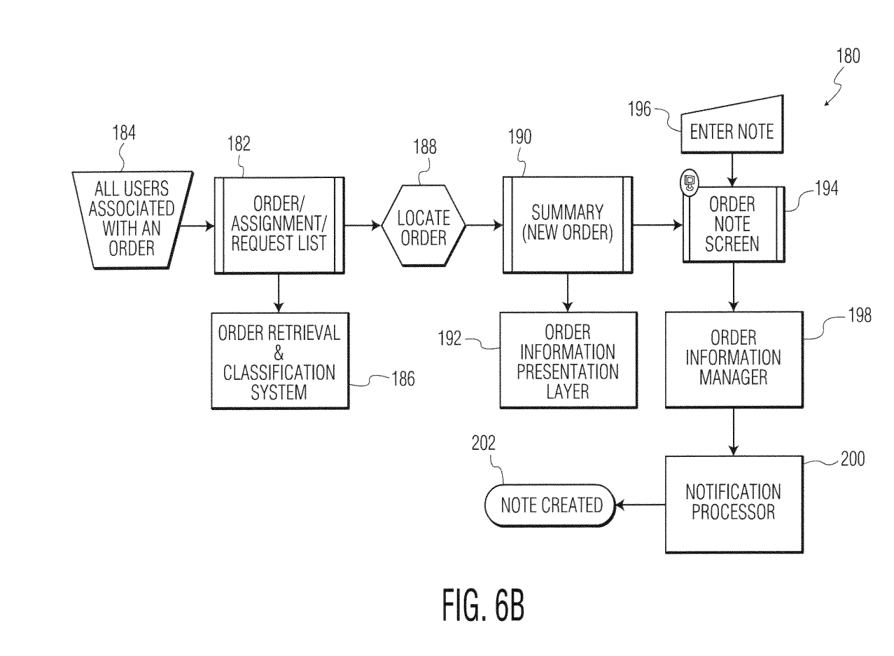

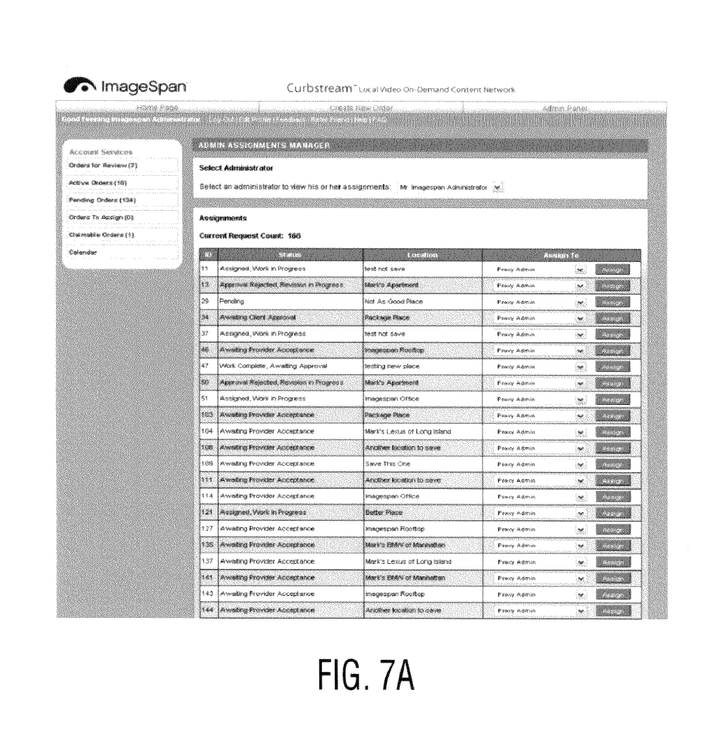

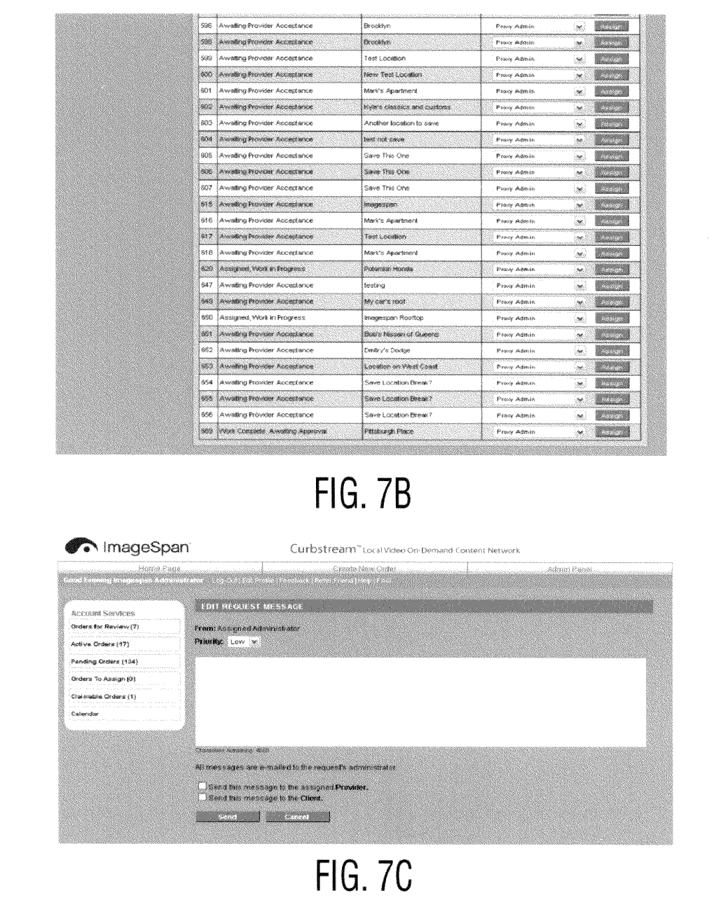

Referring to FIGS. 6A-6B and 7A-7C, shown in FIG. 6A is a flowchart of processing steps according to the present invention, indicated generally at 160, for allowing an administrator to assign orders for content to other administrators. Each order for content is assigned by the present invention to a specific administrator so that the administrator can review and supervise the content production process, and such assignments can be changed as desired so that other administrators are assigned to an order. For example, if a particular administrator will not be available during a scheduled shooting, the administrator can assign another administrator to the assignment. In step 162, an administrator 164 (e.g., the administrator 26 of FIG. 1) is provided with screens, shown in FIGS. 7A-7C, which allow the administrator to manage production assignments and assign a new administrator to an assignment. Management of assignments is accomplished using an order retrieval and classification subsystem 172 and an assignments manager 170. The administrator can select a request to re-assign a production assignment to a new administrator provider in step 166, or a new administrator can be specified in step 168. In step 174, an order workflow processor is initiated, wherein the administrator's selection of a new administrator is matched/linked to an order for content. In step 176, a notification processor is initiated, wherein the selected administrator is provided with a notification that he/she has been assigned to the order. In step 178, the order is re-assigned to the new administrator.

Shown in FIG. 6B are processing steps according to the present invention, indicated generally at 180, for allowing users to create notes regarding an order for content. In step 182, the user (e.g., a content provider, an requester of content, or an administrator) is provided with a user-specific list generated by the order and retrieval classification system 186. In step 188, the user locates a desired order from the list. In step 190, the user is provided with a summary of an order, which is generated by an order information presentation layer 192. In step 194, the user is presented which a screen (see FIG. 7C) which, in step 196, allows the user to add a note about an order for content. In step 198, the notes are processed by an order information manager, and in step 200, the notes are communicated to a recipient, which could include a content provider, a content requester, or an administrator. In step 202, processing completes.

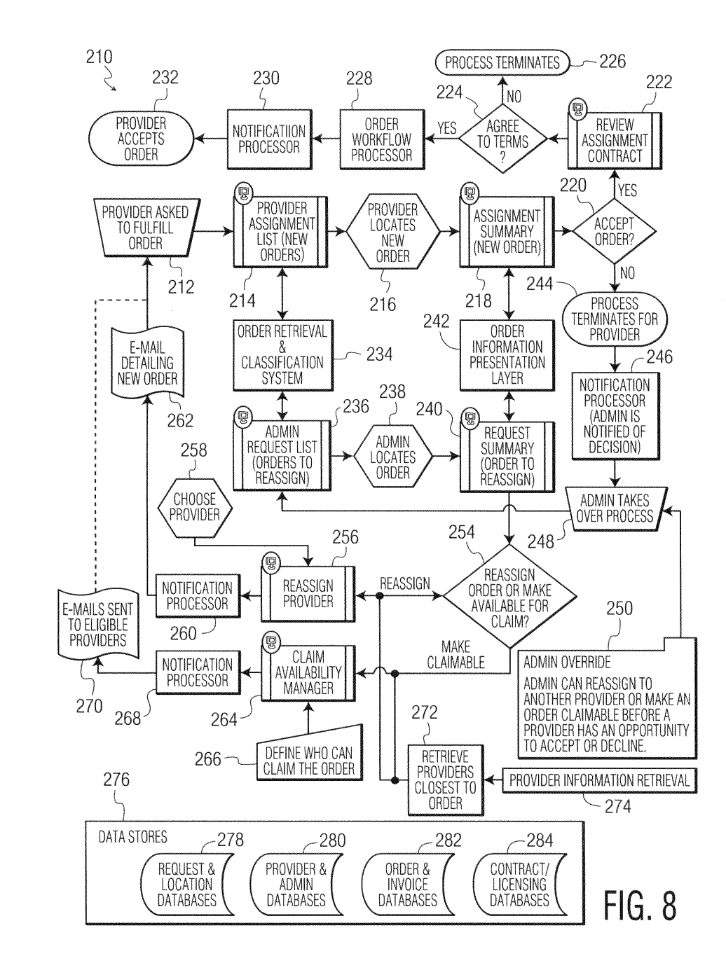

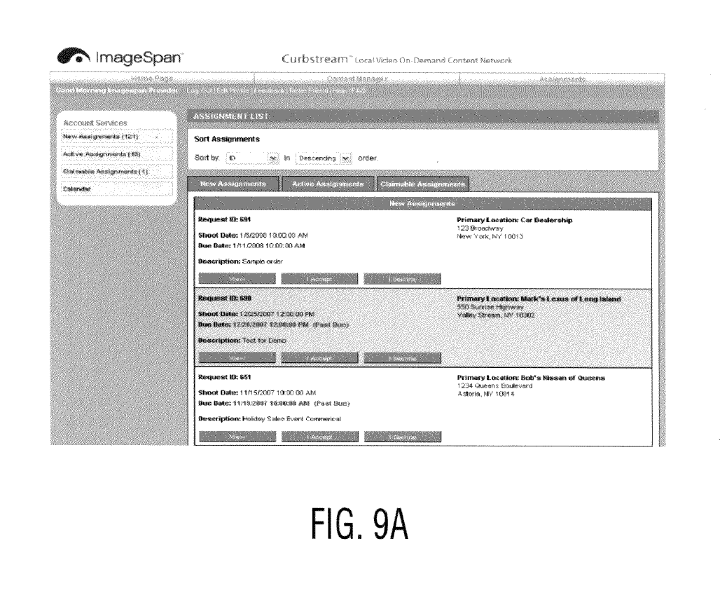

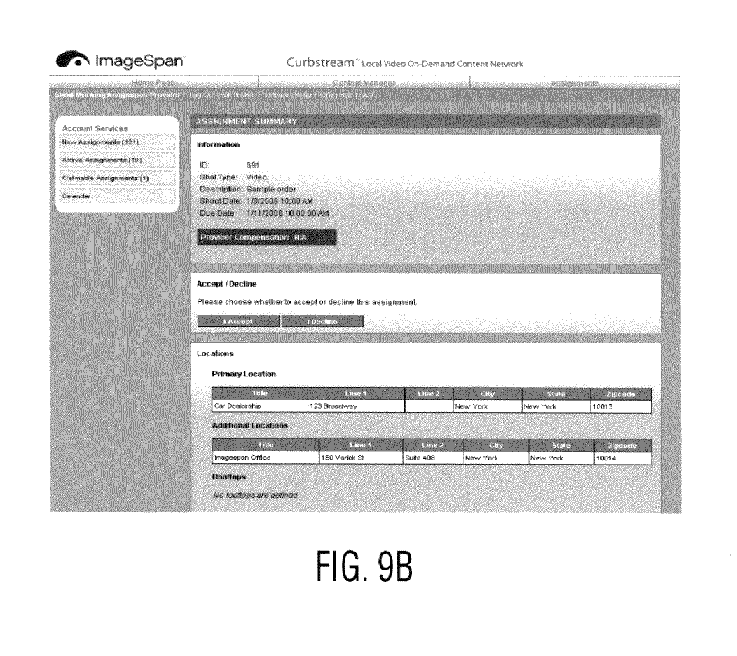

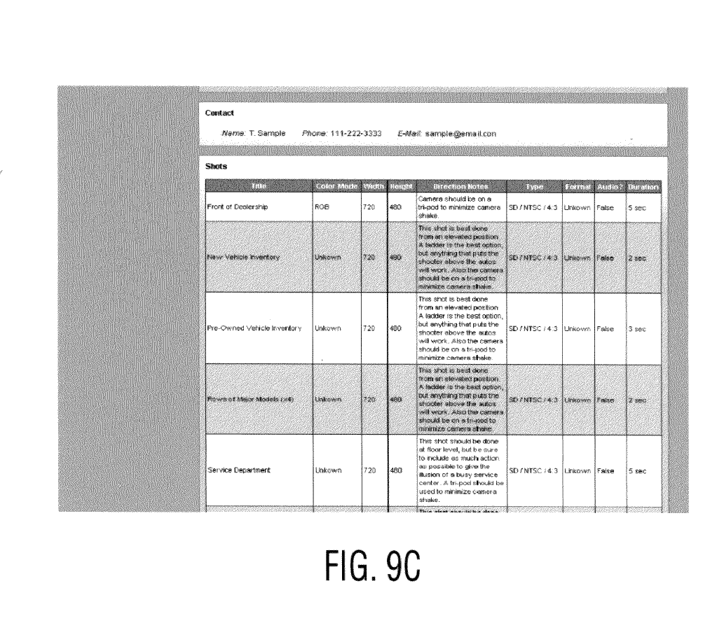

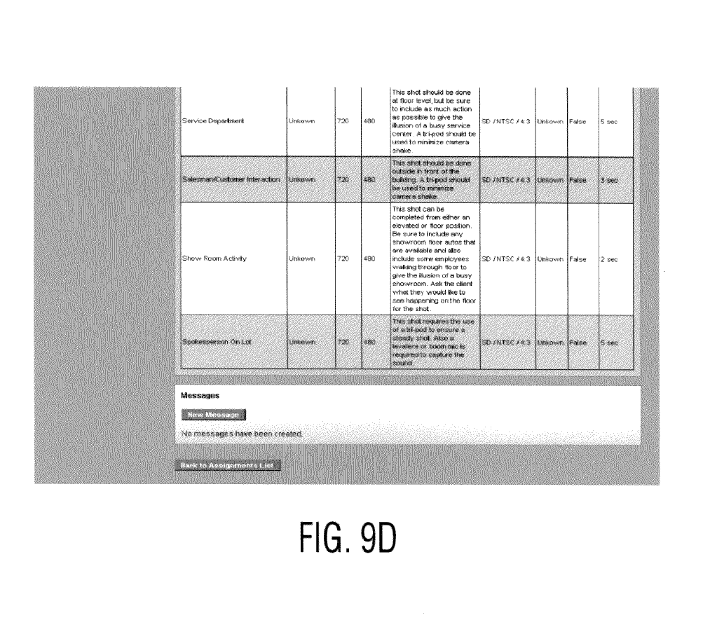

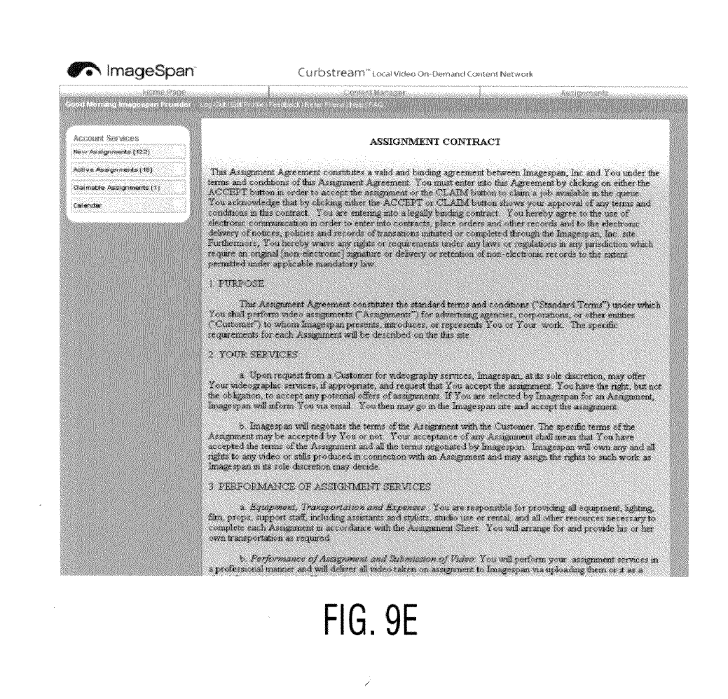

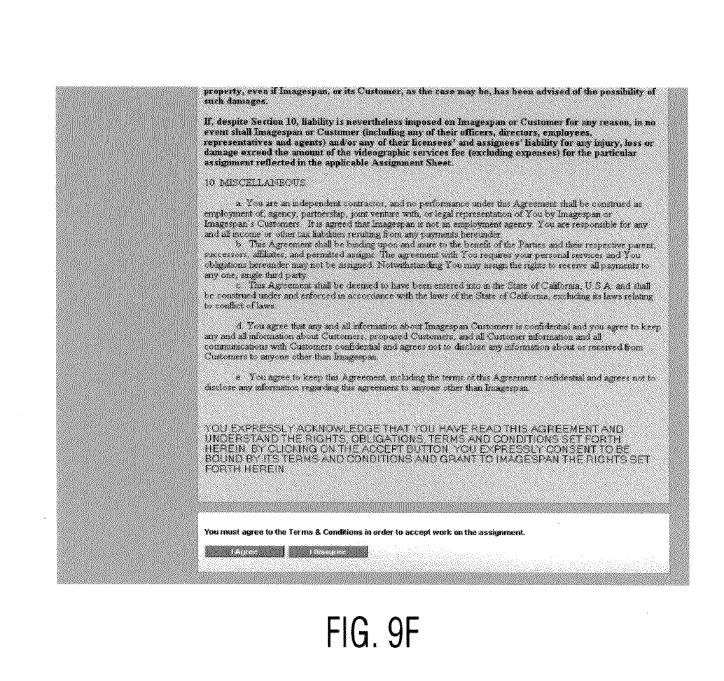

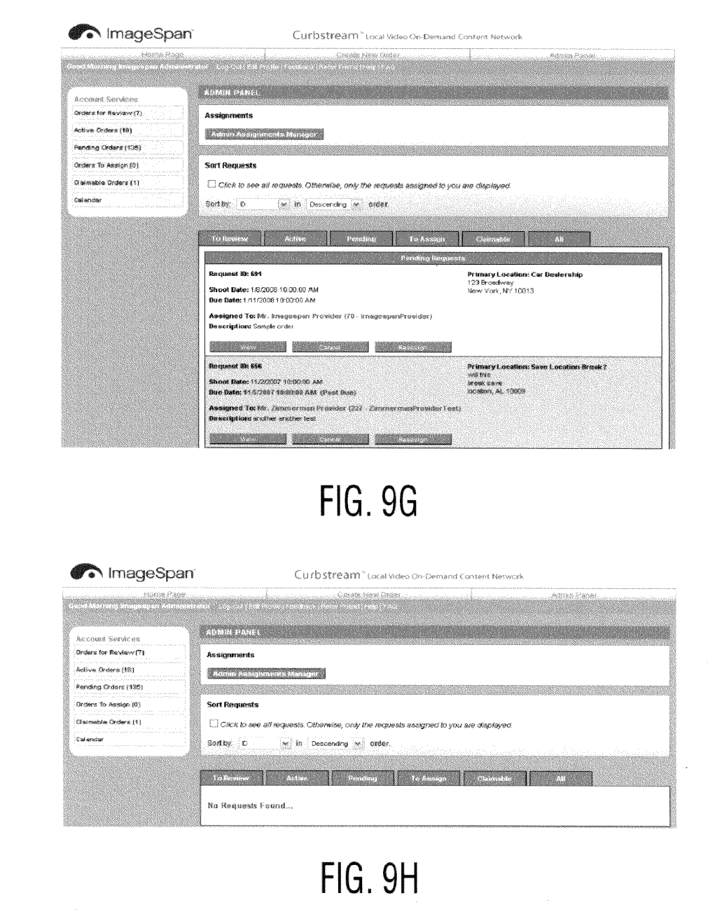

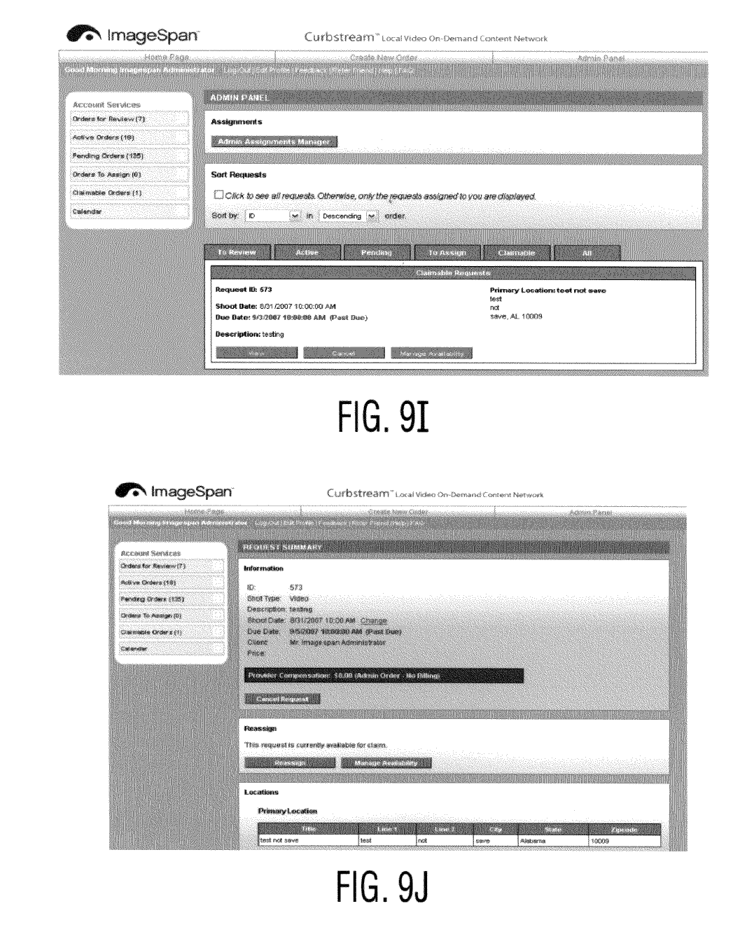

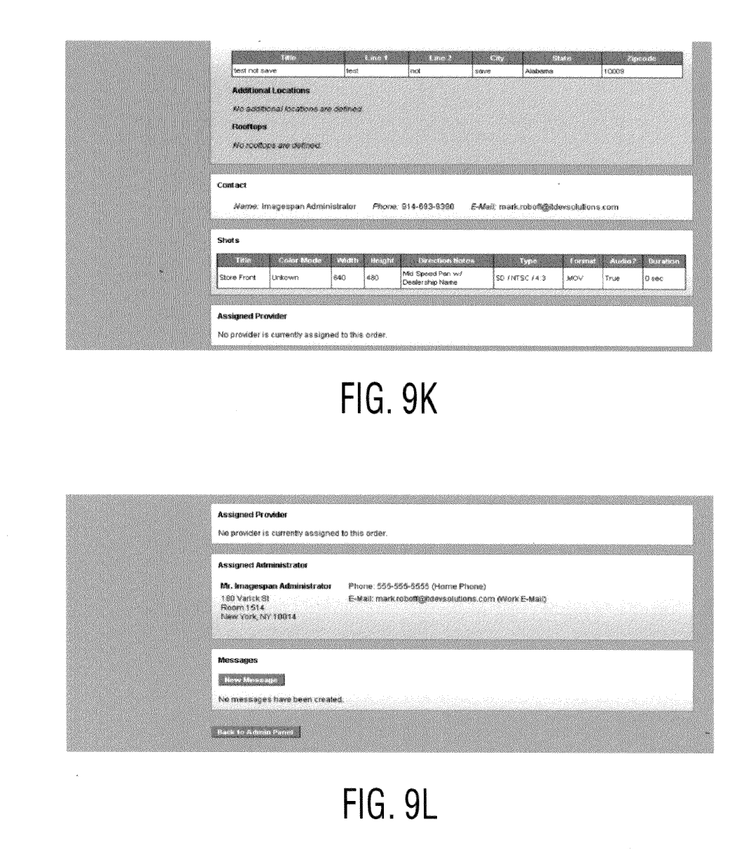

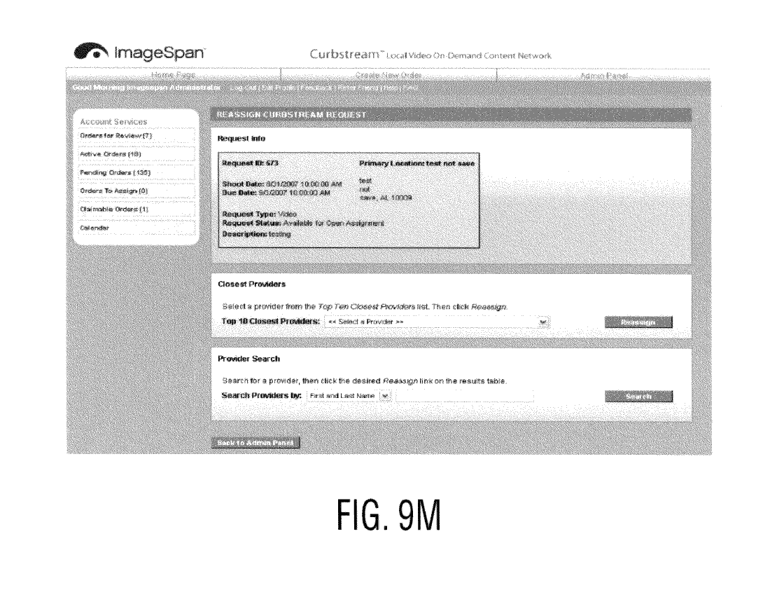

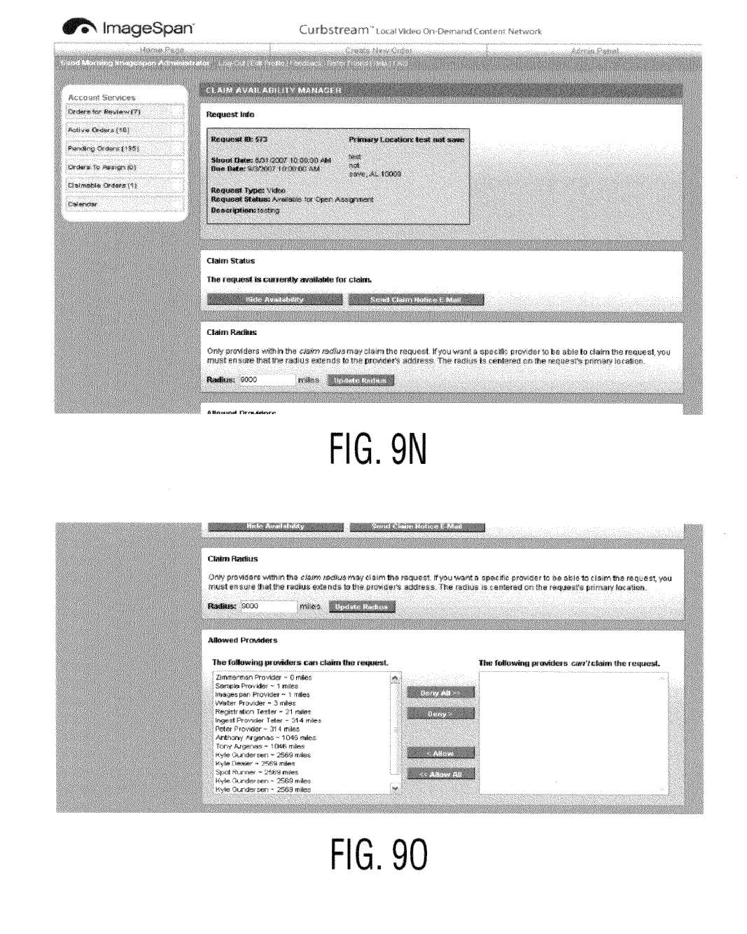

Referring to FIG. 8 and FIGS. 9A-9O, shown in FIG. 8 is a flowchart of processing steps according to the present invention, indicated generally at 210, for allowing a content provider (e.g., one or more of the content providers 20a-20c of FIG. 1) to review, select, and accept production assignments for content ordered by a user. In step 212, the content provider is asked to fulfill an order for content provided by a user. To do this, in step 214, the content provider is presented with a list of assignments (see FIG. 9A), which is populated by an order retrieval and classification system 234. In step 216, the content provider locates a new order from the list. In step 218, the content provider is provided with a summary of the new order, as shown in FIGS. 9B-9D. The assignment summary provides information about the order for content, including an identifier corresponding to the order, shot type, description, shoot date, and due date, as well as location information, a contact individual at the location, desired shots specified in the order, and any relevant messages for the content provider. This information is provided in step 242 by an order information presentation layer. In step 220, the content provider decides whether to accept the order (e.g., by clicking an “I Accept” button, as shown in FIG. 9B). If so, step 222 occurs, wherein the content provider is presented with an assignment contract, which specifies the legal terms and conditions for the assignment. An example assignment contract is depicted in FIGS. 9E-9F. In step 224, the content provider decides whether to accept the terms of the assignment contract. If not, processing terminates in step 226. If the content provider does accept the terms of the assignment contract (e.g., by clicking on an “I Agree” button, as shown in FIG. 9F), steps 228-230 occur, wherein the accepted assignment is processed by an order workflow processor and a notification processor. The content provider follows the assignment and any relevant notices and instructions, travels to the location(s) identified in the order at the specified date(s) and time(s), and creates the content (e.g., creates a video using a digital video recorder, creates an audio file using a digital audio recorder, creates a photograph using a digital camera, etc.) in accordance with the order. Processing then completes in step 232.

In the event that the content provider does not accept the order in step 220, step 244 occurs, wherein processing for the content provider terminates. Then, in step 246, a notification processor is invoked, wherein an administrator (e.g., the administrator 26 of FIG. 1) is notified of the content provider's decision to decline the assignment. Then, in step 248, the administrator takes over the process, wherein in step 250, the administrator can re-assign the assignment to another provider, or make an order claimable before a provider has an opportunity to accept or decline the order. In step 236, the administrator is provided with screens which enable the administrator to re-assign the order, as shown in FIGS. 9G-9I. The screens operate in conjunction with the order retrieval and classification system of step 234 to provide information about orders. In step 238, the administrator locates an order. Then, in step 240, the administrator requests a summary of the order, which is provided in step 242 by the order information presentation layer. The summary is shown in FIGS. 9J-9L.

In step 254, the administrator decides whether to re-assign the order to a new content provider, or to make it available to be claimed by new content provider. If a determination is made to re-assign the order, step 256 occurs, wherein the administrator is provided with a screen for re-assigning the order, as shown in FIG. 9M. In steps 272 and 274, information about content providers is provided to the administrator to facilitate selecting a new content provider, including information about content providers which are closest the location where the content is to be produced. In step 258, the administrator chooses a new provider, and the order is then assigned to the new provider. In step 260, a notification processor is invoked, wherein an e-mail 262 detailing the order is provided to the new content provider. The new content provider can then process the order as discussed hereinabove. If the administrator decides in step 254 to make the order available to be claimed, step 264 occurs, wherein the administrator is provided with a plurality of claim availability management screens, as shown in FIGS. 9N-9O. Steps 272-274 occur, wherein information about content providers, including the content providers closest to the location where content is to be produced, is provided to the administrator. Also, in step 266, the administrator can define any content provider who can claim the order. Using the screens shown in FIGS. 9N-9O, the administrator define an area (radius) about the production location, and can specify that only content providers located within the area can claim the assignment. After the assignment has been made claimable, in step 268, a notification processor is invoked, wherein e-mails 270 are sent to eligible content providers. The first content provider to respond to the e-mail can then accept the order as discussed hereinabove. It is noted that the information processed by the steps of FIG. 8 could be stored in data stores 276, which could include a request and location database 278, a provider and administrator database 280, an order and invoice database 282, and a contract/licensing database 284.

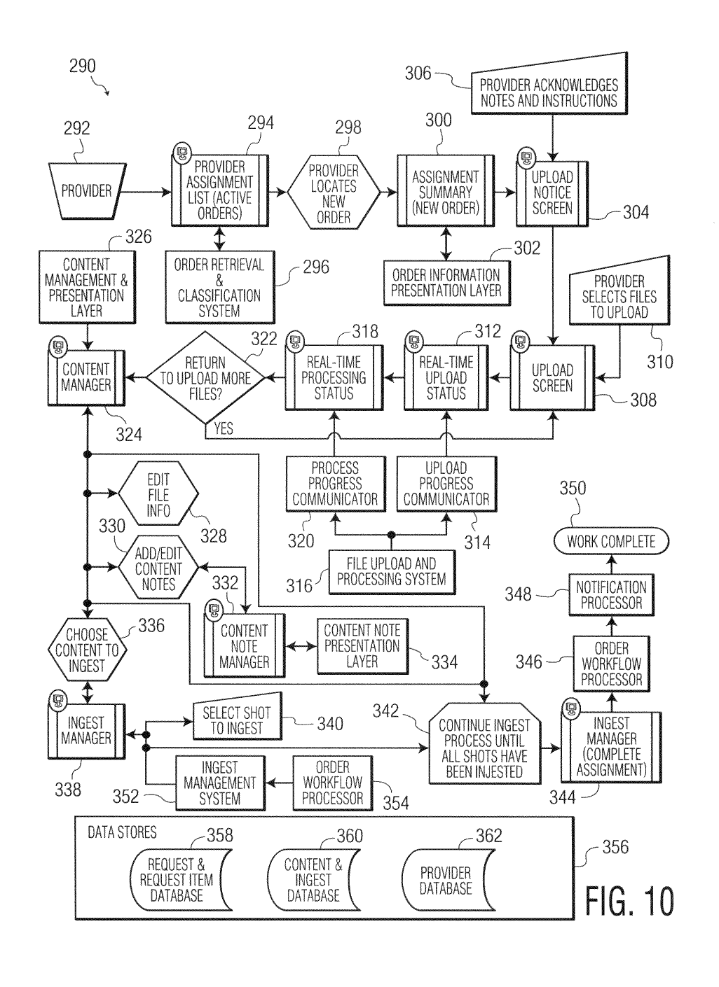

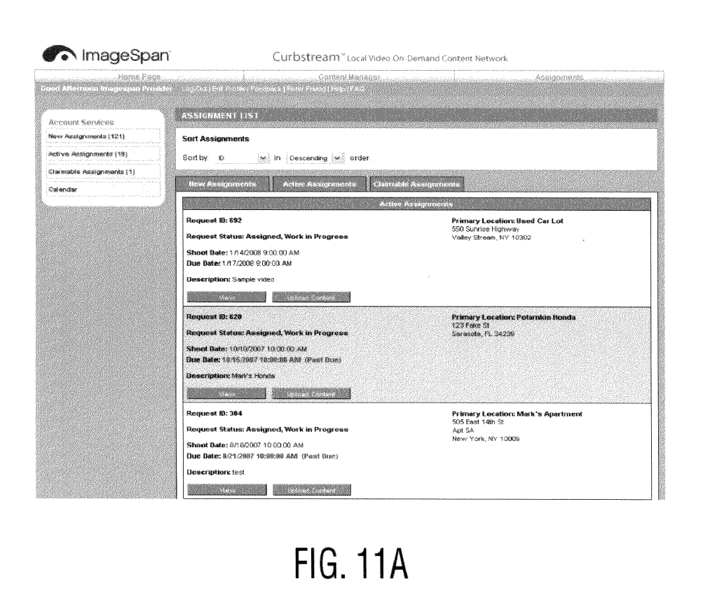

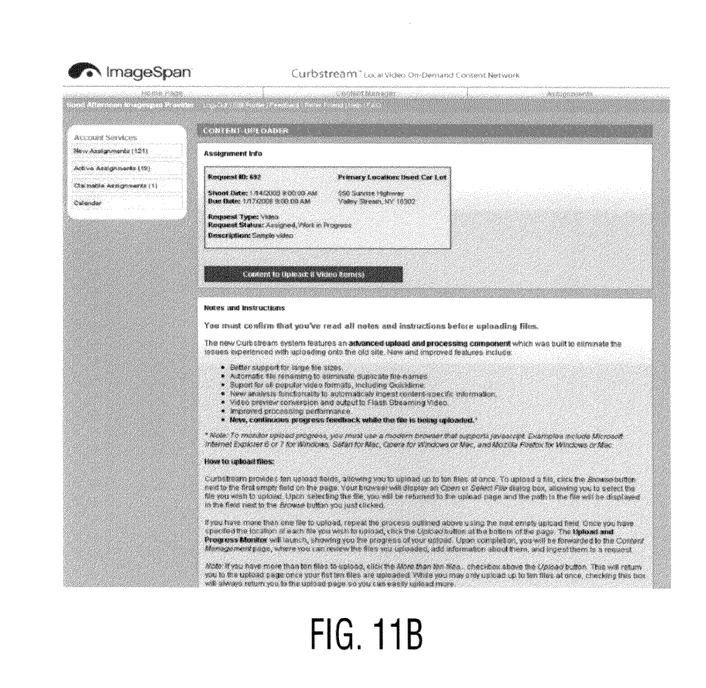

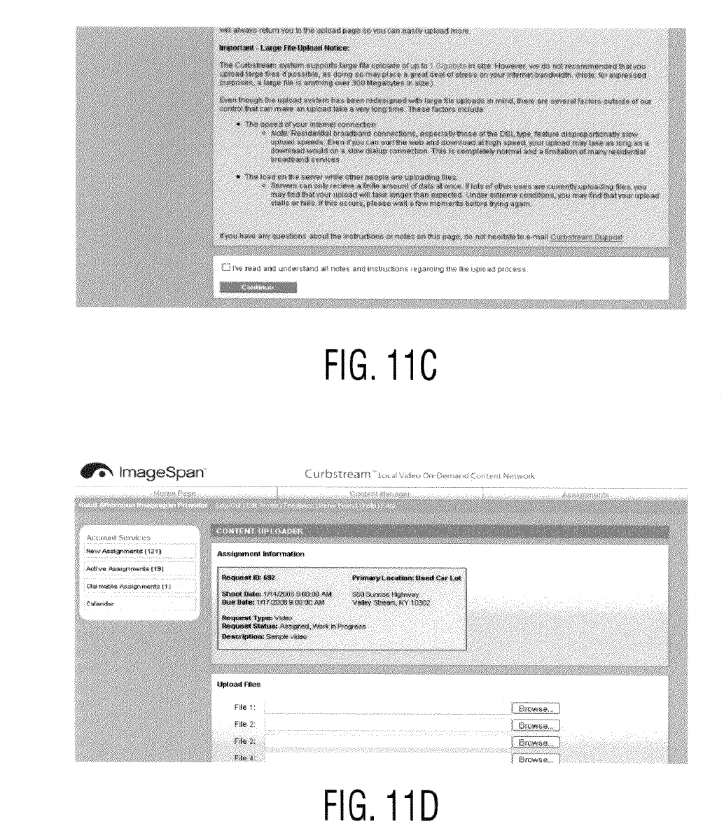

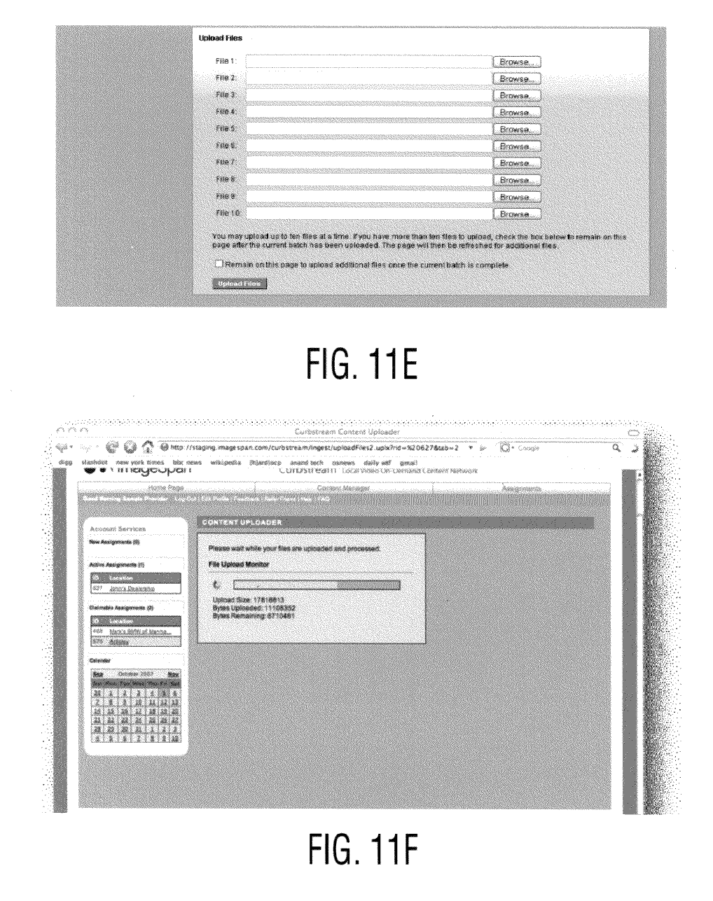

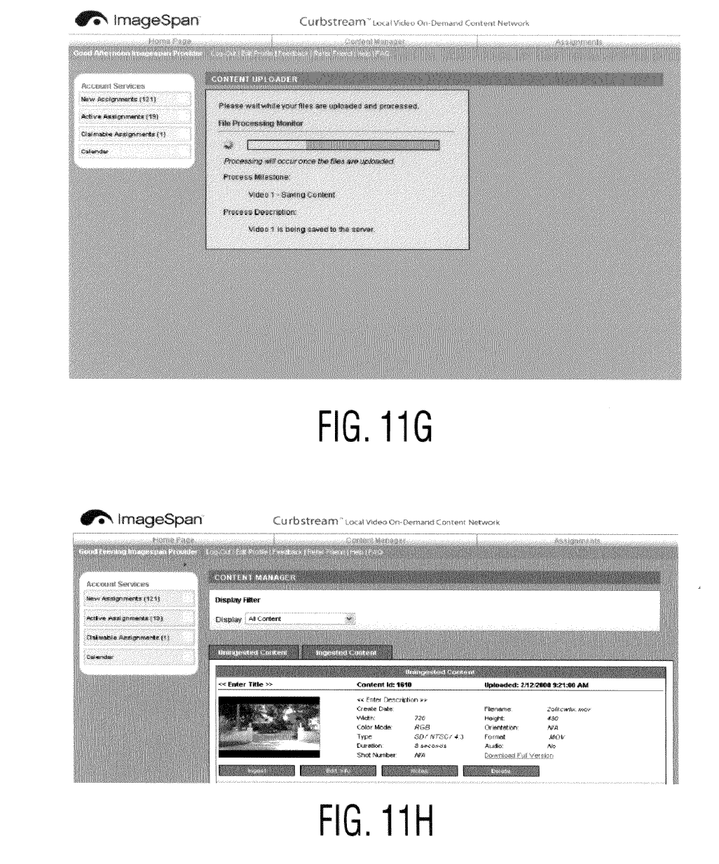

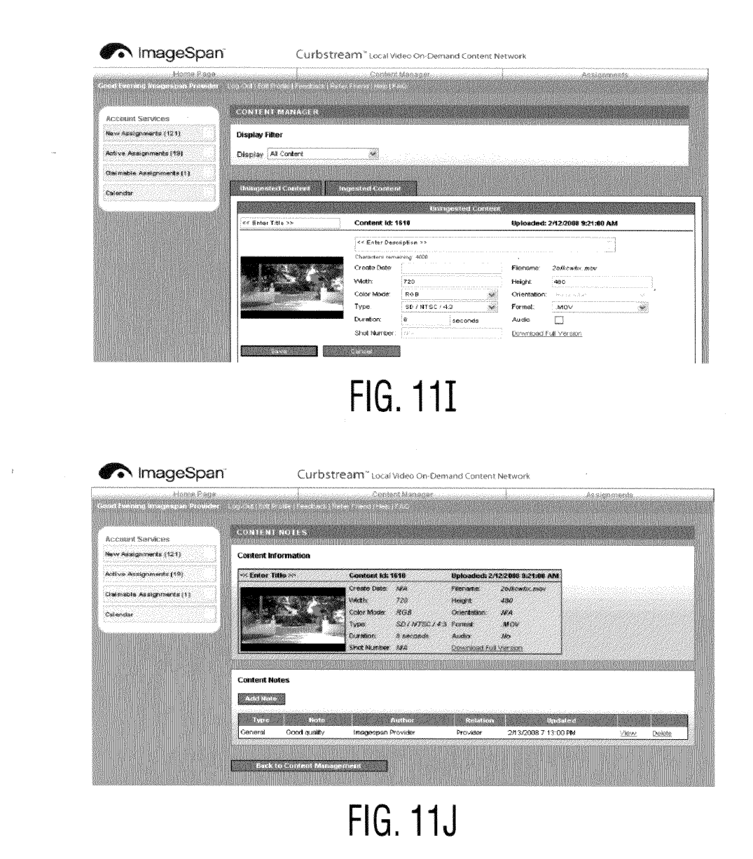

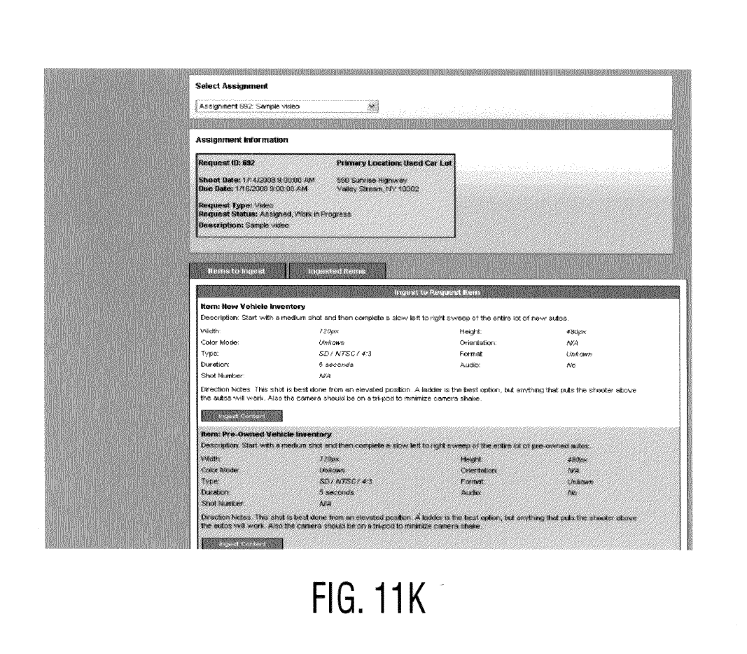

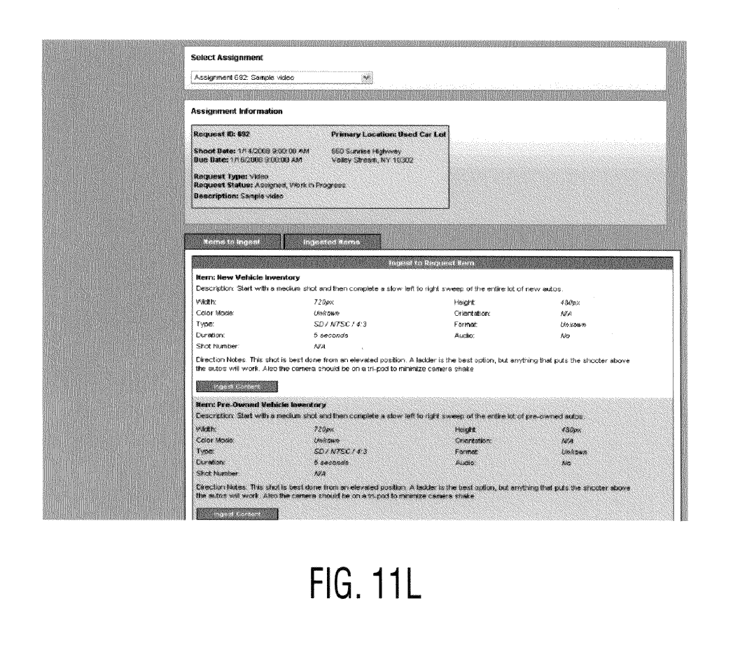

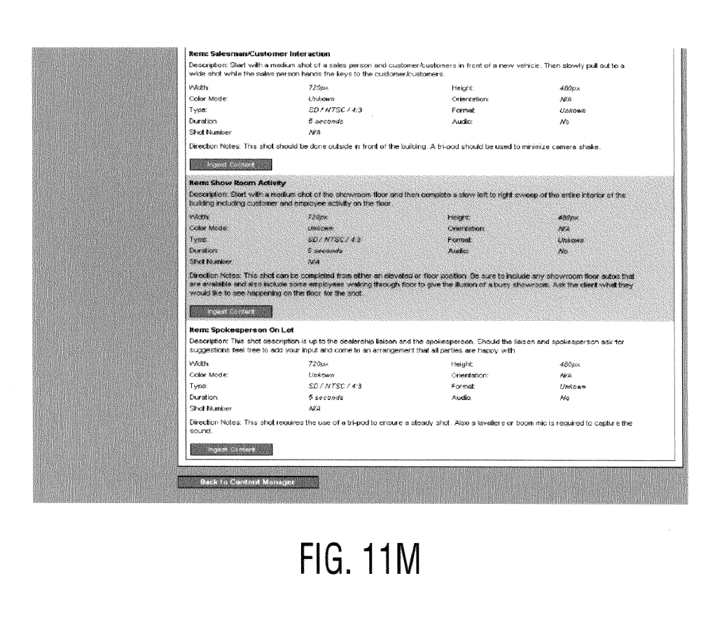

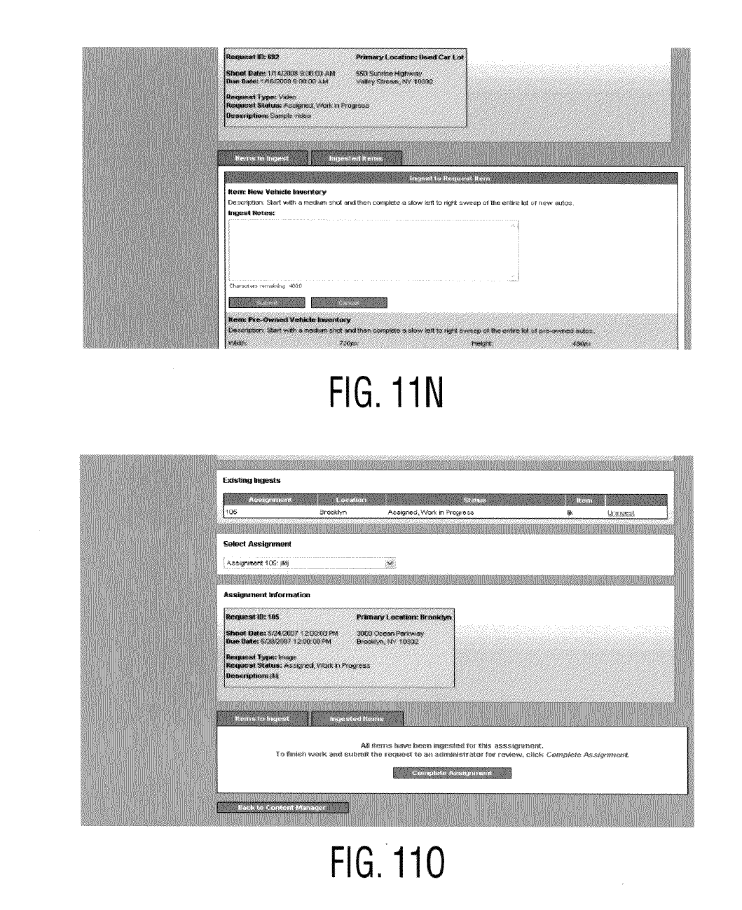

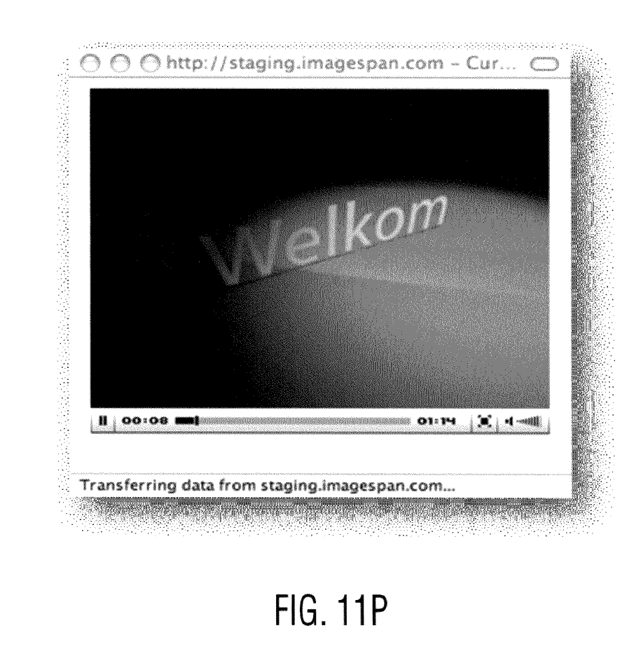

Referring to FIG. 10 and FIGS. 11A-11P, shown in FIG. 10 is a flowchart of processing steps according to the present invention, indicated generally at 290, for allowing content providers to upload content for a production assignment and to manage uploaded content. In step 294, a content provider 292 (e.g., one or more of the content providers 20a-20c of FIG. 1) is provided with a screen (shown in FIG. 11A) for allowing the content provider to select from a list of active assignments (i.e., a list of active orders for which the content provider has agreed to produce content). In step 298, the content provider locates a new order using the screen. In step 300, the content provider is presented with an assignment summary (see FIG. 11A), which allows the content provider to review a summary of the assignment. The summary provides the content provider with necessary information for producing content in accordance with an order, as described above. This information is provided in step 302 by an order information presentation layer.

After an order has been selected and the assignment summary reviewed, step 304 occurs, wherein the content provider is presented with screens (see FIG. 11B-11C) which provide the user with notices and instructions concerning the uploading of content. In step 306, the content provider acknowledges the notices and instructions (see FIG. 11C). After the content has been created, step 308 occurs, wherein the content provider is provided with screens (see FIGS. 11D-11E) for uploading one or more files containing the content. Any suitable file format could be supported by the present invention, such as video file formats (e.g., MPEG, MOV, AVI, WMV), photo file formats (e.g., JPEG, TIFF, GIF), etc.). In steps 312 and 318, while the files are uploading to the present invention, the content provider is provided with real-time status updates regarding the uploading and processing of content files. The status information is conveyed in real time using the screens shown in FIGS. 11F-11G, and status information is provided by a file upload and processing system 316, an upload progress communicator 314, and a process progress communicator 318. The real time status information does not require a user to install third-party software (e.g., a browser plug-in, or a JAVA applet), thereby providing a seamless user interface experience. AJAX technology is used by the present invention to poll the web server 14 of FIG. 1 to acquire information about the number of bytes uploaded, and the information is displayed in real time to the user, without disrupting the upload process. This approach also maintains a streamlined interface with other web components.

In step 322, the content provider makes a determination as to whether there are additional files to be uploaded. If so, steps 308-318 are repeated as necessary to upload and process the additional files. Otherwise, step 324 occurs, wherein the content provider is presented with screens for managing the uploaded content (see FIGS. 11H-11I), which interface with a content management and presentation layer 326. In step 328, the content provider can edit file information. In step 330, the content provider can add or edit notes relating to the content, using a screen presented to the content provider for this purpose (see FIG. 11J). Such a screen could interface with a content note presentation layer 334. In step 336, the content provider chooses content to be ingested by the present invention. By the term “ingest,” it is meant assigning an uploaded file to a particular requirement (e.g., a shot) specified in a particular order for content. The ingestion process is facilitated using a plurality of screens, as shown in FIGS. 11K-11O. In step 340, using the ingest screens, the content provider can select shots to be ingested. The ingestion process could communicate with an ingest management system 352 and an order workflow processor 354 to facilitate ingestion of uploaded content. In step 342, the ingestion process continues until all shots have been selected/identified by the content provider.

In step 344, the content provider is provided with a final screen (see FIG. 11O) for completing the ingestion process. Once complete, steps 346-350 occur, wherein order workflow and notification processors are initiated and an administrator (e.g., the administrator 26 of FIG. 1) is notified that content has been uploaded and is ready to be reviewed. After successful review by the administrator (i.e., the uploaded content is found to be acceptable by the administrator), a content requester (e.g., one or more of the businesses 12a-12c of FIG. 1) is notified of the uploaded content, and is asked to review the content. If no deficiencies are found, the order is indicated as being complete, and the content is delivered to the content requester. As shown in FIG. 11P, a screen could be provided to the content provider to allow for online review of uploaded and/or ingested content. It is noted that the information processed by the steps of FIG. 290 could be stored in data stores 356, which could include a request and request item database 358, a content and ingestion database 360, and a provider database 362.

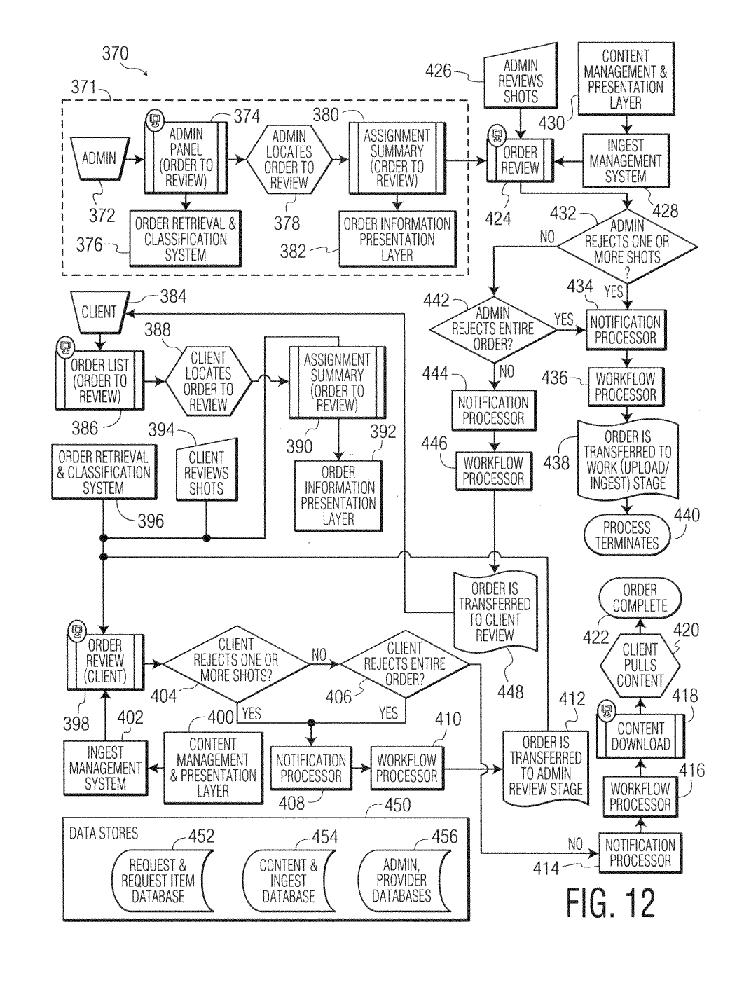

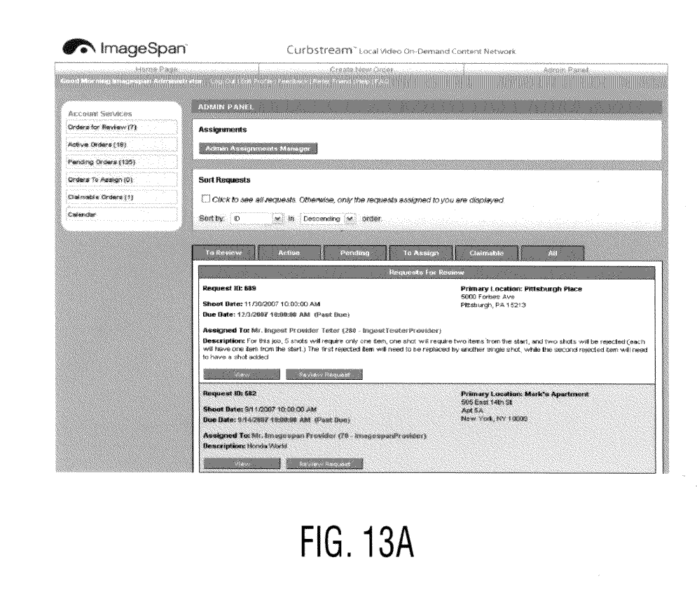

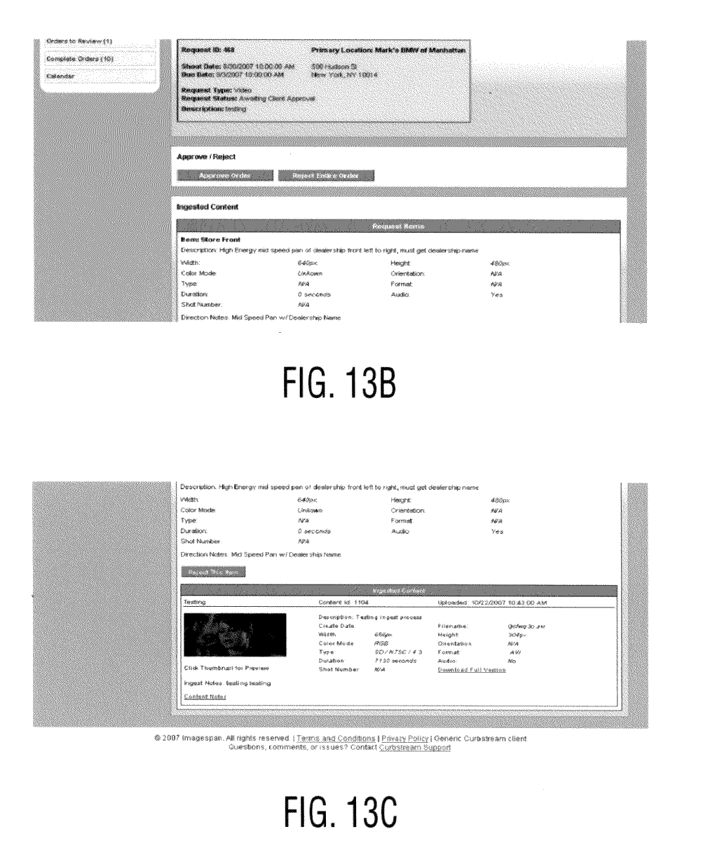

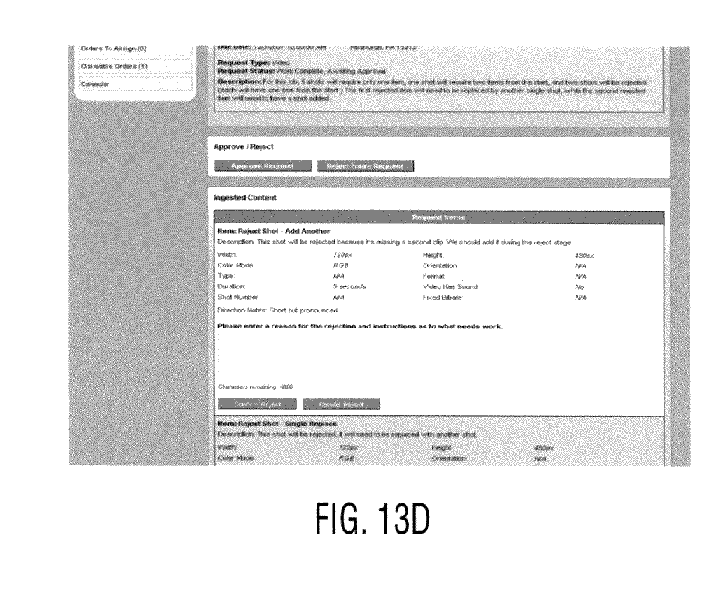

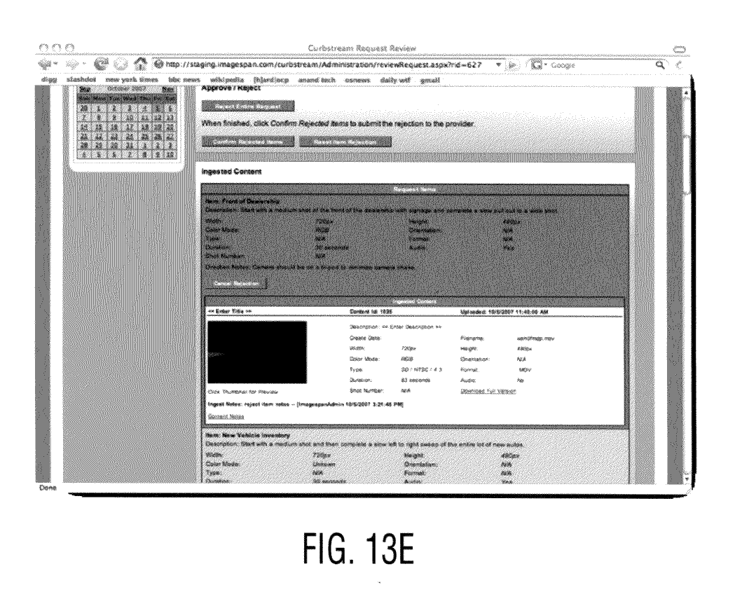

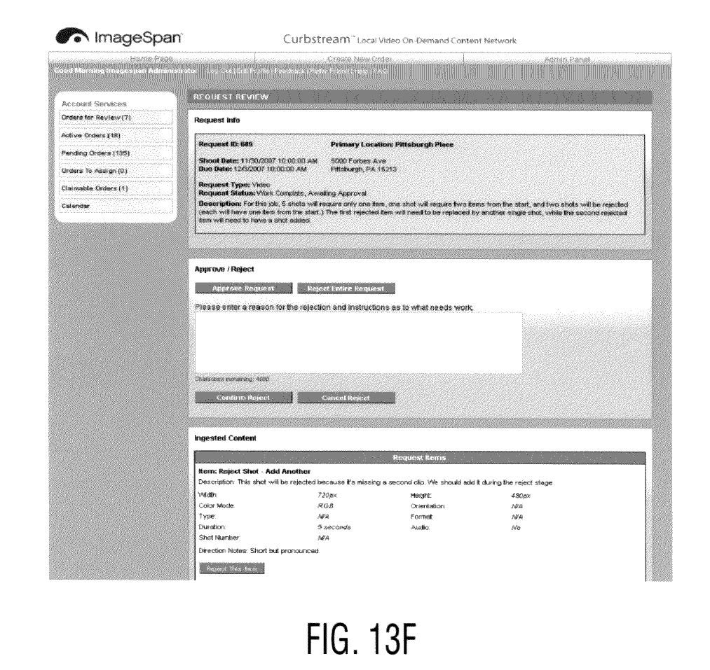

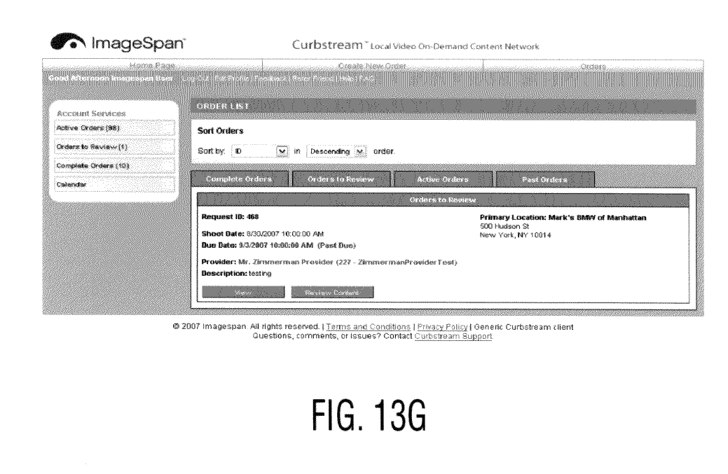

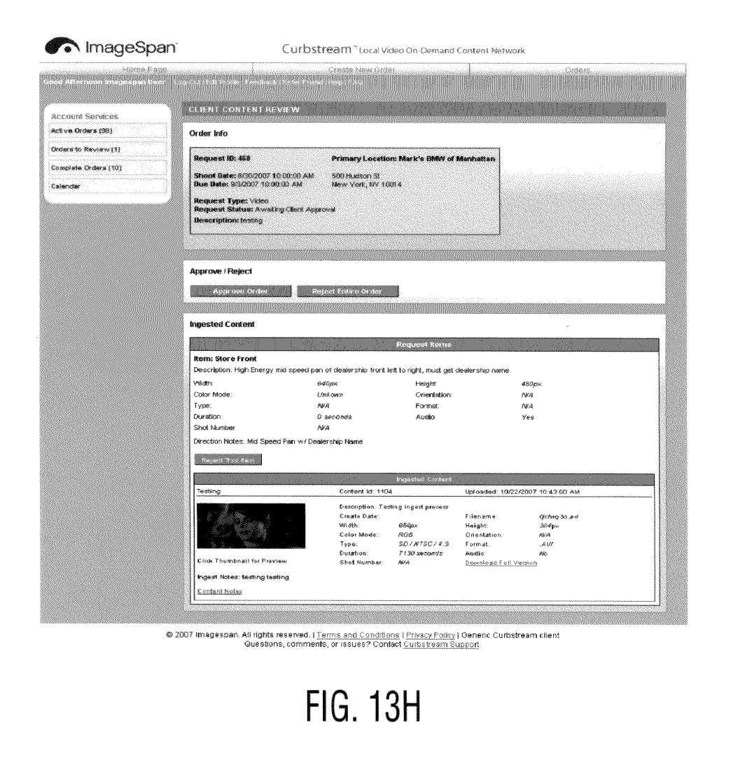

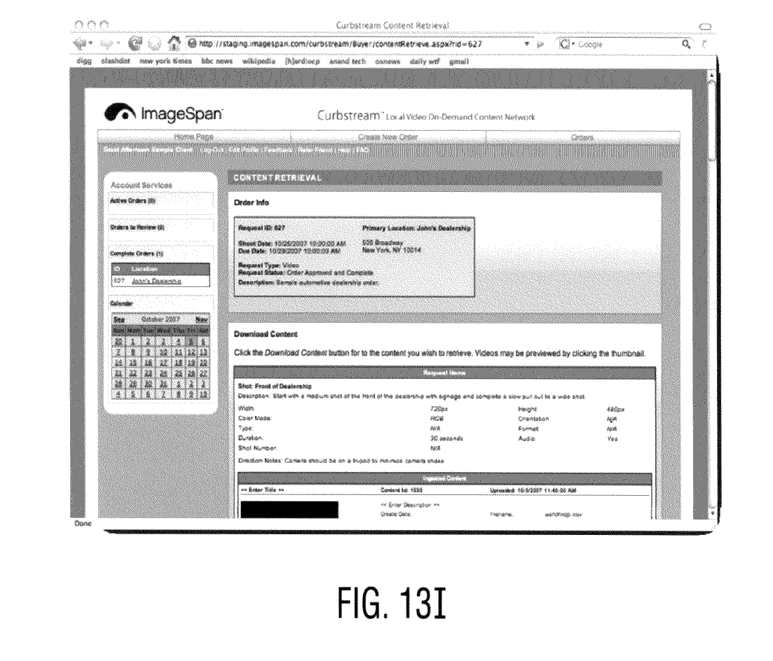

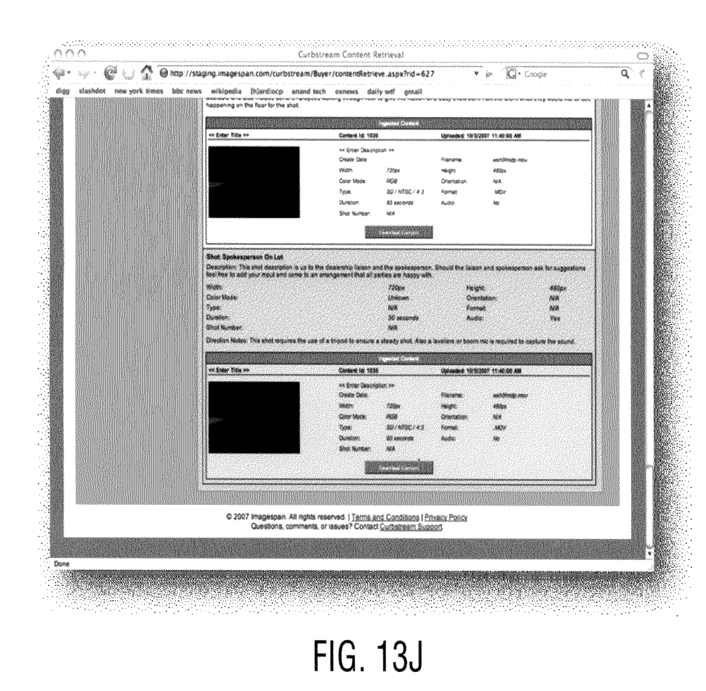

Referring to FIG. 12 and FIGS. 13A-13J, shown in FIG. 12 is a flowchart of processing steps according to the present invention, indicated generally at 370, for allowing administrators to review content provided by a content provider and for allowing a content requester to download content. In process 371, an administrator 372 (e.g., the administrator 26 of FIG. 1) can select an order to review from a list of orders. The list is presented to the administrator in step 374 using the screen shown in FIG. 13A. Order information is provided by an order retrieval and classification system 376. In step 378, the administrator locates an order to review. Once located, step 380 occurs, wherein a summary of an order (assignment) is presented to the administrator (see FIG. 13A). The summary is provided by an order information presentation layer 382.

In step 424, the administrator is provided with a plurality of screens (see FIGS. 13B-13F) for allowing the administrator to review uploaded content to ensure that it complies with pre-defined quality control standards and/or with an order for content. In step 426, the administrator can review one or more shots of the content. The order review process can interface with an ingest management system 428 (as discussed above) and a content management presentation layer 430. In step 432, the administrator determines whether or not to review one or more shots of an order. If a negative determination is made, step 442 occurs, wherein the administrator decides whether to reject the entire batch of content for the order. If a negative determination is made, steps 444, 446, and 448 occur, wherein the content is processed as being acceptable and a notification is provided to a content requester/client (e.g., one or more of the businesses 12a-12c of FIG. 1) indicating that the content is available for downloading.

If positive determinations are made in steps 432 or 442 (i.e., one or more shots for an order, or an entire batch of content for an order, are found to be unacceptable), steps 434-440 occur, wherein the deficiency is processed, a notification is sent to the content provider that the shot(s) and/or content is unacceptable, and the order is transferred to a “work” (e.g., upload/ingest) stage for remedying by the content provider responsible for creating the content, or a substitute content provider. It is noted that the present invention can automatically review uploaded content provided by the content provider to determine whether the content complies with one or more parameters of an order for content and/or a production assignment. If any deficiencies are found, they can be automatically highlighted in a summary screen and conveyed to the administrator and/or content provider for remedying.

In step 386, a client 384 (e.g., one or more of the businesses 12a-12c of FIG. 1) can select an order to review after the client has received notification that content is available to be downloaded, using the interface screen shown in FIG. 13G. In step 388, the client locates an order to review. In step 390, when an order has been selected, the client is provided with a screen for reviewing a summary of the order (assignment), as shown in FIG. 13H. This screen is populated by an order information presentation layer 392. In step 398, the client can review the order to determine whether it complies with the client's specifications, using the screen shown in FIG. 13H. This screen could interface with an order retrieval and classification system 396, an ingest management system 402, and a content management and presentation layer 400. In step 394, the client can review shots of the content uploaded by a content provider to determine if the shots are acceptable. In step 404, the client decides whether to reject one or more shots of the content. If a negative determination is made, step 406 occurs, wherein the client decides whether to reject an entire batch of content corresponding to the order. If a negative determination is made, steps 414-416 occur, wherein notification of the accepted order is processed by the present invention. If positive determinations are made in steps 404 and 406, steps 408-412 occur, wherein a notification is generated that the content is unacceptable, and the order is transferred to an administrator for review, as discussed hereinabove.

In step 418, the client is provided with screens for downloading the content, as shown in FIGS. 131-13J. In step 420, the client then downloads (“pulls”) the content, and in step 422, the order is complete. It is noted that the information processed by the steps of FIG. 12 could be stored in data stores 450, which could include a request and request item database 452, a content and ingestion database 454, and an administrator and provider databases 456.

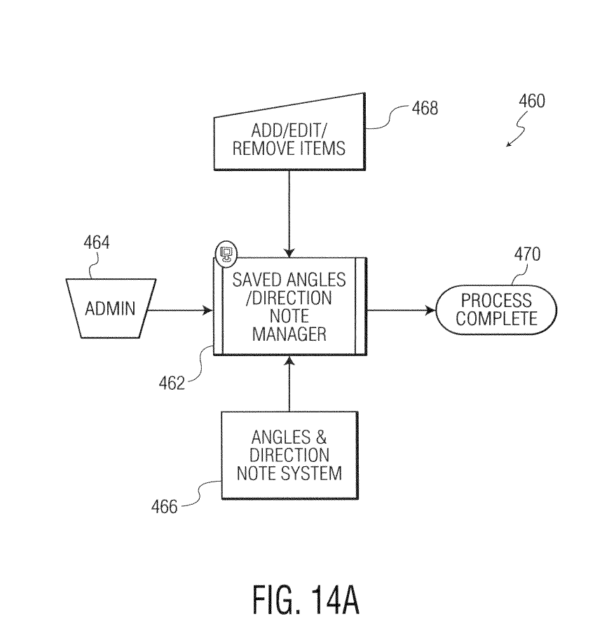

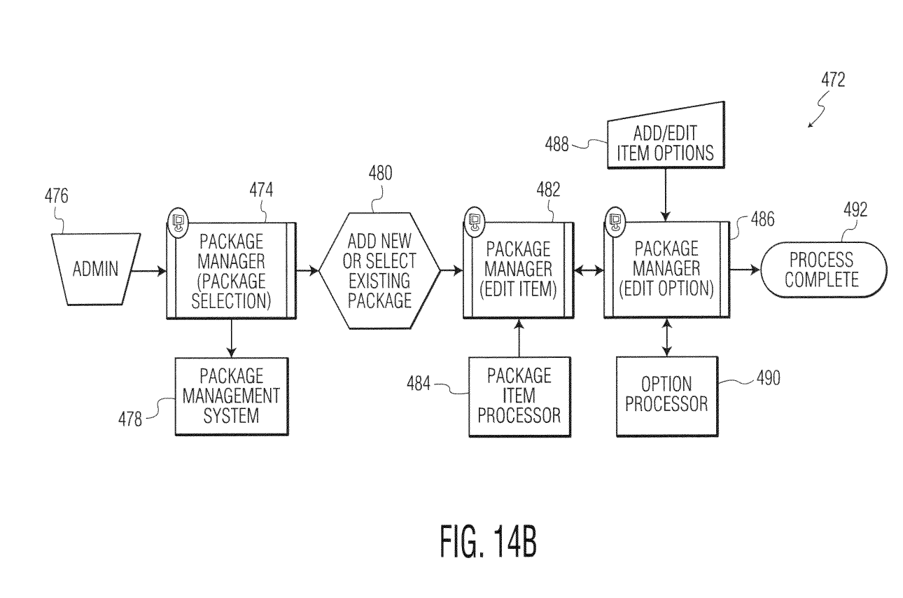

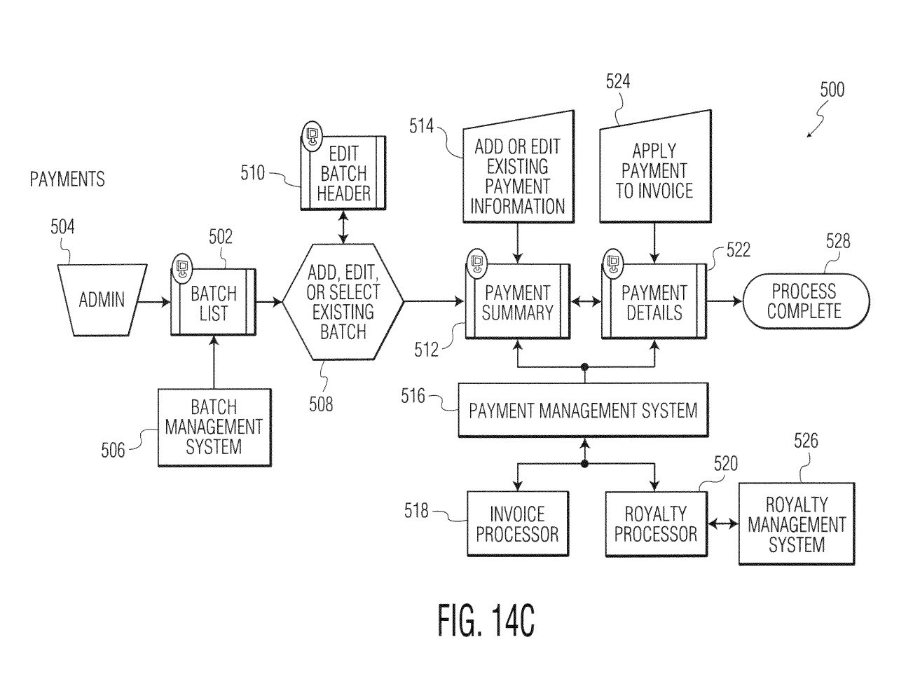

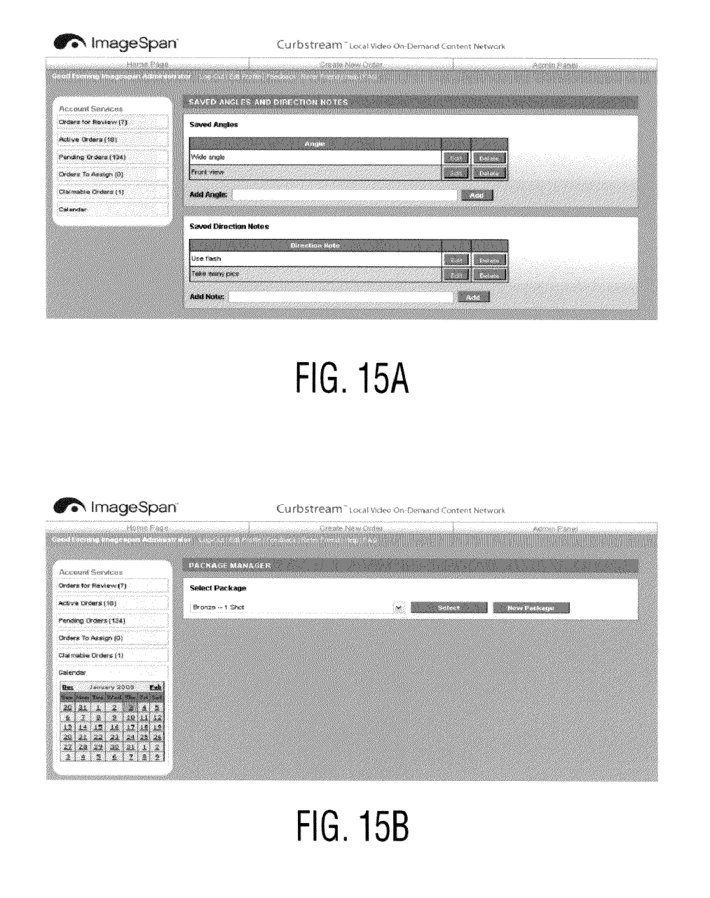

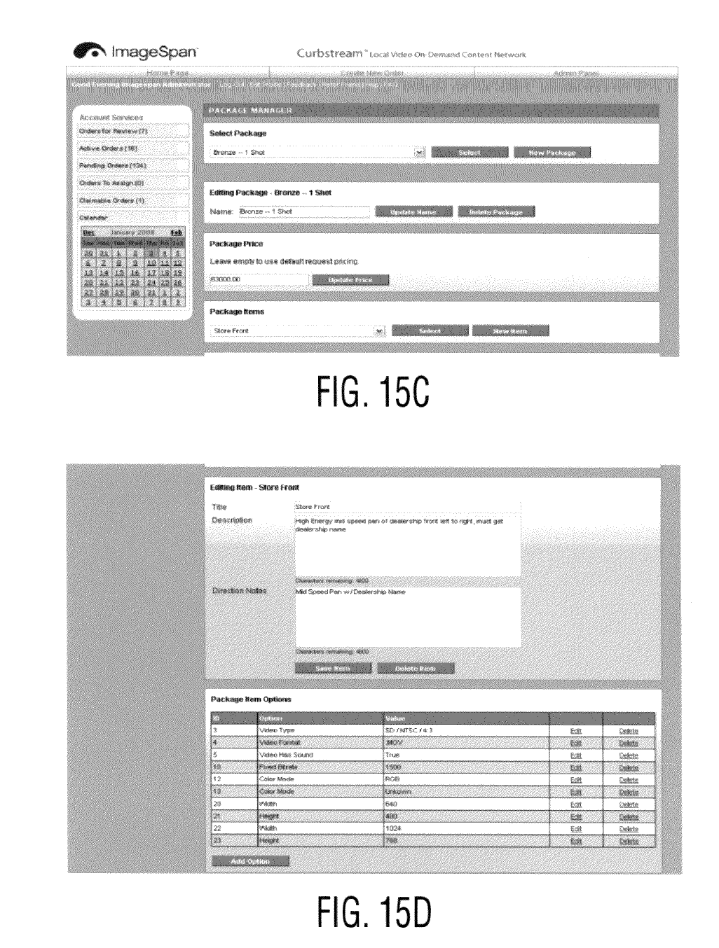

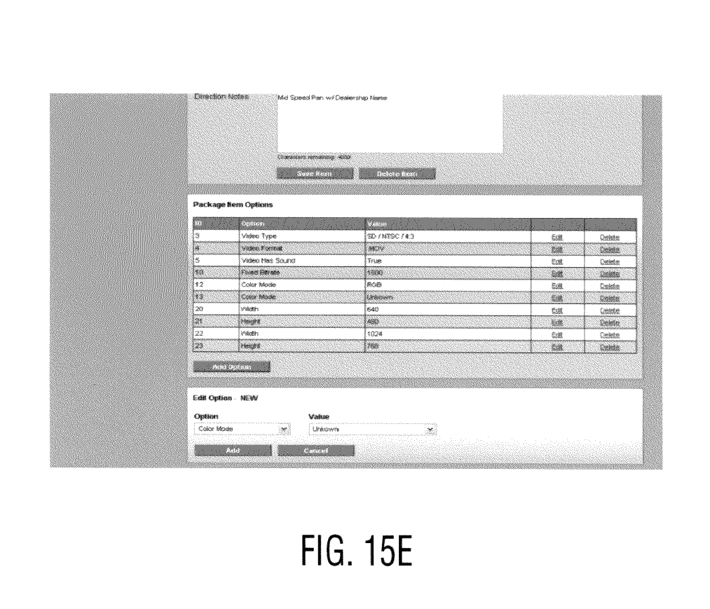

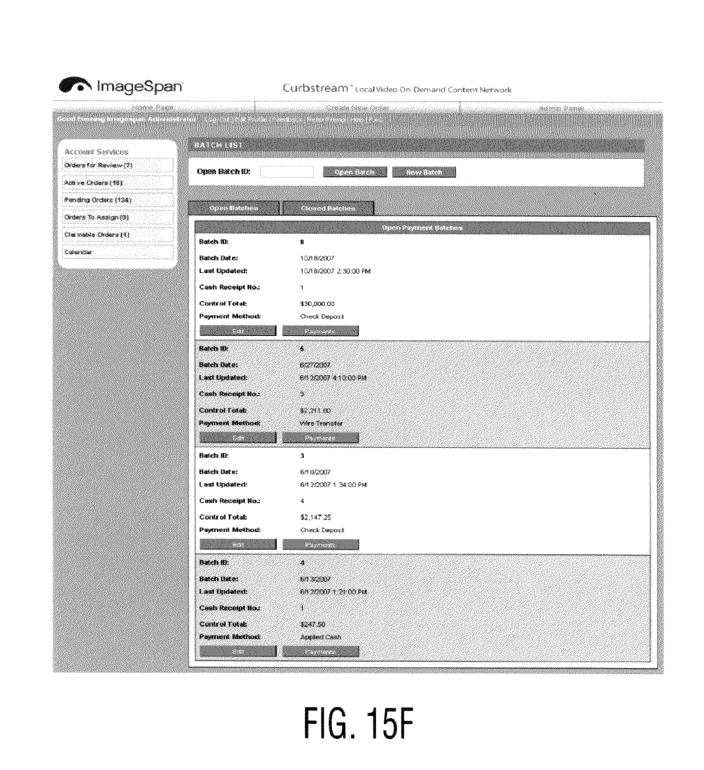

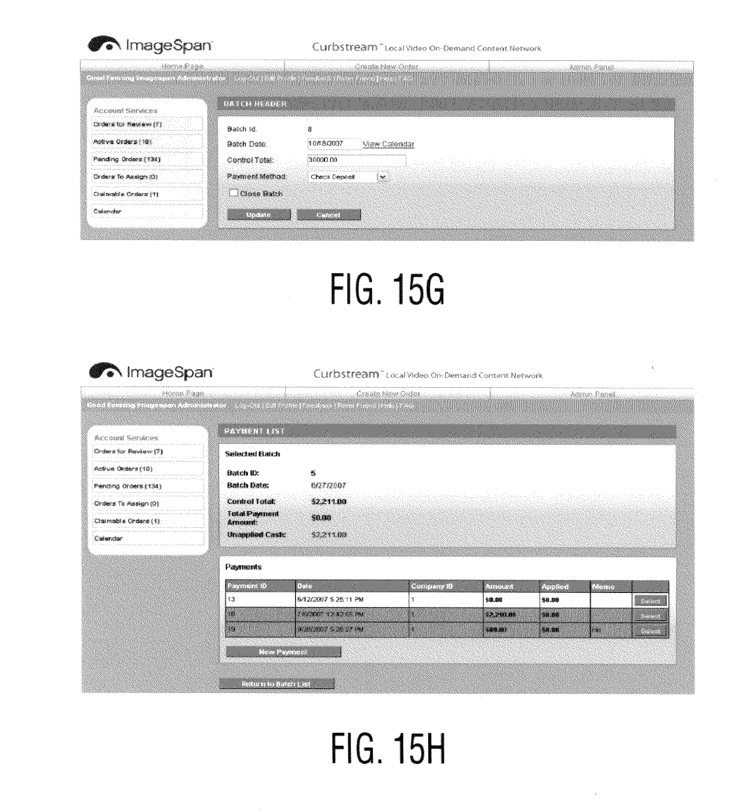

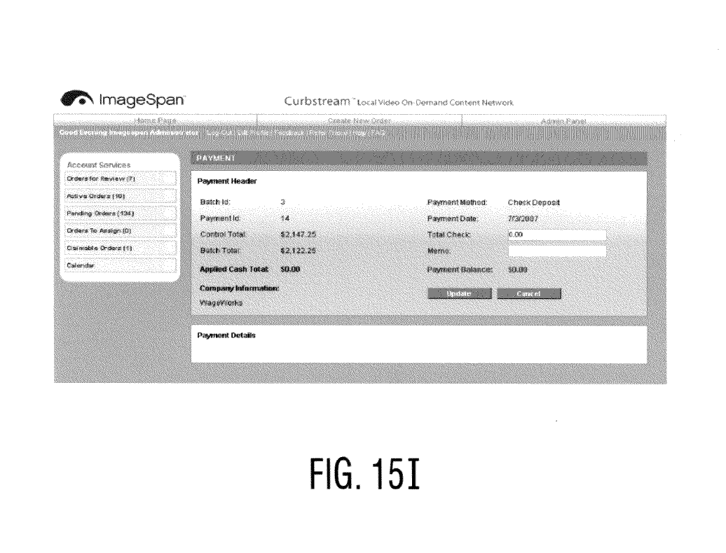

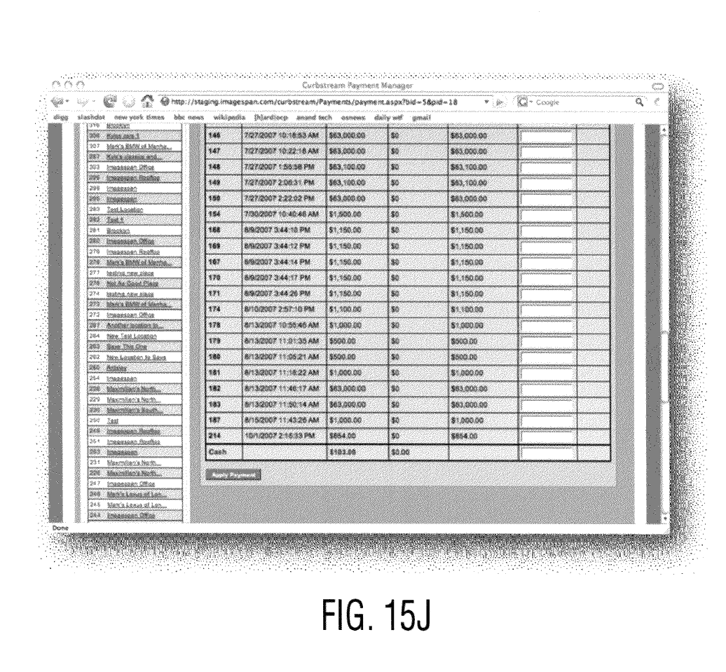

Referring now to FIGS. 14A-14C and 15A-15J, shown in FIG. 14A is a flowchart of processing steps according to the present invention, indicated generally at 460, for allowing administrators to create angle and direction notes for customized orders. In step 462, an administrator 464 (e.g., the administrator 26 of FIG. 1) is presented with the screen shown in FIG. 15A, which allows the administrator to create, save, or modify angles for an assignment, and to create, save, or modify direction notes regarding an assignment. An angles and notes direction system 466 operates with the screen to store and retrieve angle and direction notes. In step 468, the administrator can add, edit, or remove items, such as additional angles to be captured by a content provider and notes regarding the production of content. Processing completes in step 470 after all angles/notes have been created/edited and saved.

Shown in FIG. 14B is a flowchart of processing steps according to the present invention, indicated generally at 472, for allowing an administrator to manage packages. Packages according to the present invention include pre-defined orders having pre-defined package items (e.g., desired shots), which can be customized by a business. A package order includes pre-defined rules as to how many shots can be included in an order, and pre-defined parameters relating to such shots. Packages provide a template for an order by specifying the number and types of shots which are available to a user, and define package items which are part of a package. When an order is created using a package, parameters of each package item are utilized by the present invention to set up the order. Each package item determines how each shot in an order is set up. Additionally, package orders can have a pre-defined prices. Package items define customization rules applicable to pre-defined shots, using package item option parameters. These parameters determine a level of customization over a specific component of a shot. For example, if an option defining the length of a video is set at 20 seconds, the shot defined by the package item is limited to 20 seconds. If a second option specifying 40 seconds is set, a business can choose a desired length between 20 and 40 seconds.

Alternatively, a business can create a customized order, wherein the business defines all aspects of the order Custom orders allow business to define a desired number of shots, as well as parameters associated with each shot. Custom orders are subject to pre-defined business rules which define the price for each order. To provide an incentive for a business to select a package order, a discounted package price could be provided.

In step 474, an administrator 476 (e.g., the administrator 26 of FIG. 1) is provided with the screen shown in FIG. 15B, which allows the administrator to select a package. The screen operates with a package management system 478 to provide information about exiting packages. In step 480, the administrator selects an existing package or creates a new package. In step 482, the administrator is presented with the screens shown in FIGS. 15C-15E, which allow the administrator to edit package items and options relating to the selected package. The administrator can supply information about a package name, a package price, and information about content to be included in the package. Additionally, the administrator can specify the title of the package and provide a description and direction notes. The screens interface with a package item processor 484. In steps 486-488, the administrator can edit any option relating to a package, such as whether the video has sound, is in a color mode, the dimension of the video, orientation (e.g., horizontal/vertical), and whether the video has a fixed bitrate. The chosen options are processed by an option processor 490. After package options have been specified by the administrator, processing completes in step 492.

Shown in FIG. 14C is a flowchart of processing steps according to the present invention, indicated generally at 500, for managing batches of payments provided by content requesters (e.g., one or more of the businesses 12a-12c of FIG. 1). In step 502, an administrator 504 (e.g., the administrator 26 of FIG. 1) is presented with the screen shown in FIG. 15F, which allows the administrator in step 508 to add, edit, or select an existing payment batch. The screen interfaces with a batch management system 506 that processes payment batches. In step 510, the administrator can edit batch header information, as shown in the screen of FIG. 15G. In step 512, the administrator is presented with the screen shown in FIG. 15H, which allows the administrator in step 514 to add or edit existing payment information. In step 522, the administrator is presented with the screens shown in FIGS. 15I-15J, which allow the administrator in step 524 to apply a payment to an outstanding invoice. A payment processing system 516, an invoice processor 518, a royalty processor 520, and a royalty management subsystem 526 process payments provided by the content order and distribute royalties in accordance with pre-defined royalty distributions to one or more recipients. These components could include the system disclosed in co-pending U.S. patent application Ser. No. 11/944,051 by Shear, et al., the entire disclosure of which is expressly incorporated herein by reference in its entirety. Processing of payments is completed in step 528.

Referring to FIGS. 16 and 17A-17N, shown in FIG. 16 is a flowchart of processing steps according to the present invention, indicated generally at 530, for elevating user statuses, creating and managing contracts, and processing user surveys. In step 531, an administrator 532 (e.g., the administrator 26 of FIG. 1) is provided with the screens shown in FIGS. 17A-17C, which allow the administrator to elevate the user's status. By the term “elevate,” it is meant granting a user access to one or more features. For example, a user who has registered with an account type of “Buyer” or “Client” (e.g., one or more of the businesses 12a-12c of FIG. 1) cannot create orders until an administrator elevates the account status, so that the ability to purchase content is granted to the user. Similarly, a newly-registered content provider cannot accept and fulfill orders until an administrator has reviewed the provider's credentials and has elevated his or her account to “Provider” status, at which time the content provider can accept and fulfill orders. The screens of FIGS. 17A-17C interface with a new account information presentation layer 552. In step 540, an administrator determines whether to elevate a user. If a positive determination is made, steps 548-550 occur, wherein an activation link is sent to the user via e-mail so that the user can access the newly-granted privileges. Otherwise, step 542 occurs, wherein the rejection message creation screen of FIG. 17D is provide to the administrator so that the administrator can create a rejection message. Once the message is created, steps 544-546 occur, wherein a notification is provided to the user that elevation has been denied.

In steps 534-538, the administrator can set up a default contract to be used by content providers using the contract manager interface screens shown in FIGS. 17E-17H and a default contract generator subsystem. The contract manager screens allow an administrator to select an existing content provider or new provider, supply a contract header (containing information about the contract text, start date, end date, etc.), and specify contract line-items (e.g., commission rates, payment currencies, etc.). This allows the administrator to easily create contracts via a template approach, which can be used by a plurality of content providers.

In step 556, after a user elevation has been granted as discussed above, step 556 occurs, wherein a newly-elevated user 558 opens a link in an e-mail (as shown in FIG. 171). When the link is opened, account terms and conditions are presented to the user (as shown in FIG. 17J). In step 560, the user decides whether to accept the terms and conditions. If a negative determination is made, processing ends in step 562. Otherwise, in step 564, a determination is made as to the type of account that has been created. If the user is a client or an administrator, step 582 occurs, wherein a “Thank You” screen is displayed to the user (similar to that shown in FIG. 17K), and the account is activated in step 584. If the user is a content provider, step 556 occurs, wherein the content is provided with a survey, as shown in FIGS. 17L-17M. The survey track could track information about the content provider's professional history, types of equipment used, access to a digital editing suite, experiences in shooting high-definition (HD) media, experiences with commercial productions, computer skills, Internet connectivity, travel desires, etc. The content provider completes the survey in step 568, and is provided with the “Thank You” screen shown in FIG. 17K.

In step 572, a content provider logs into the present invention, and in step 574, the content provider can review contract terms using the screen shown in FIG. 17N. The screen interfaces with a contract presentation layer 576, and in step 578, contract issues can be manually resolved with an administrator. When the account has been activated, processing completes in step 580. It is noted that the information processed by the steps of FIG. 16 could be stored in data stores 586, which could include a user/contract database 588, an administrator database 600, a provider database 602, and a contract/licensing database 604.

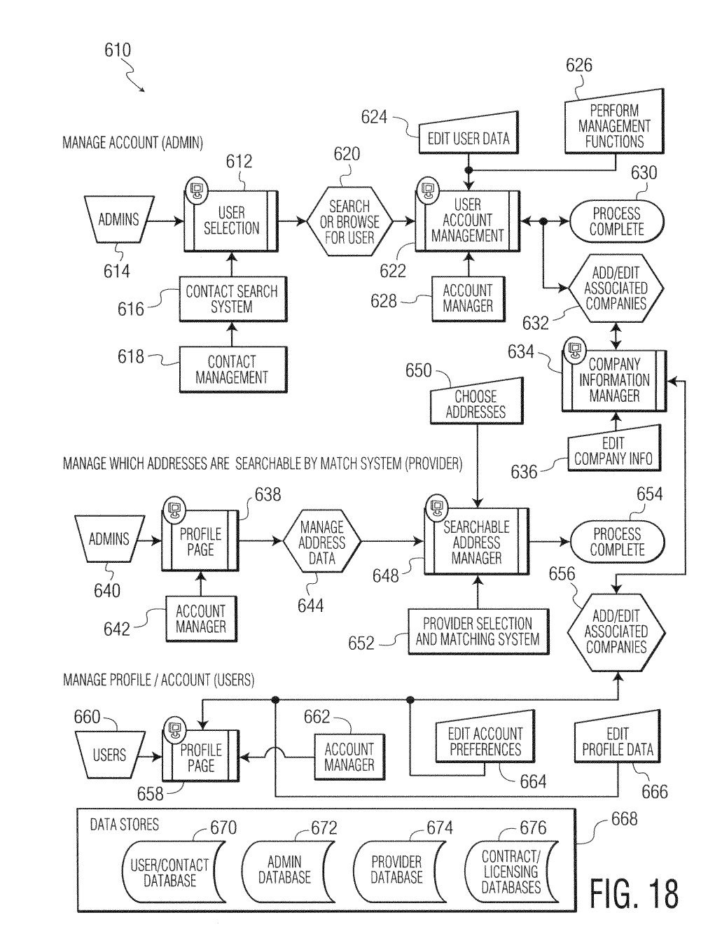

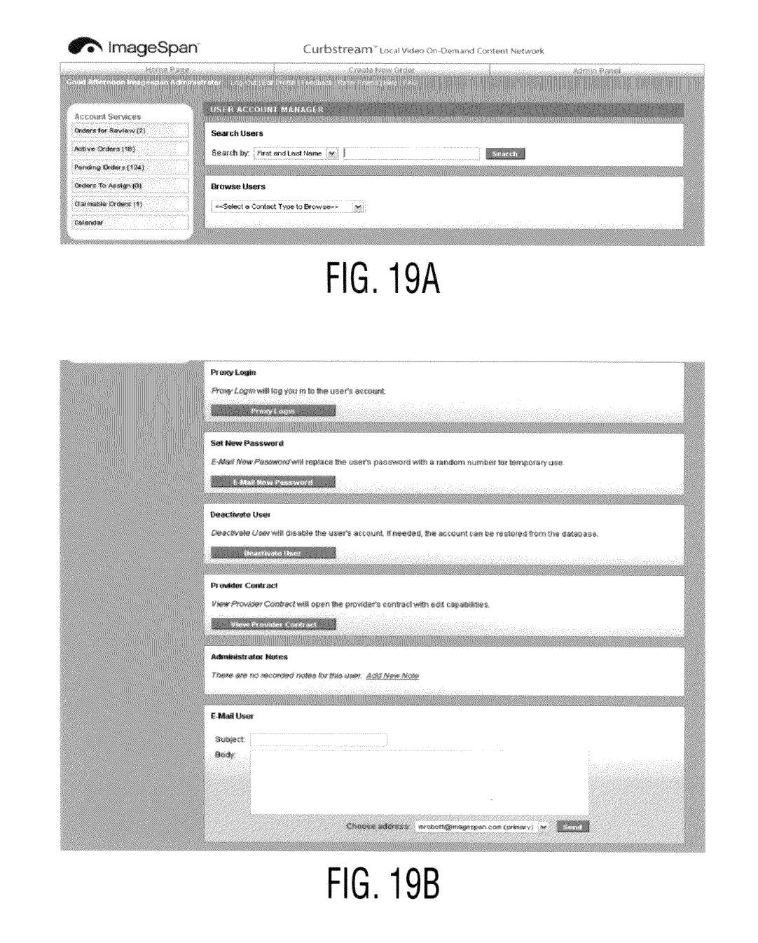

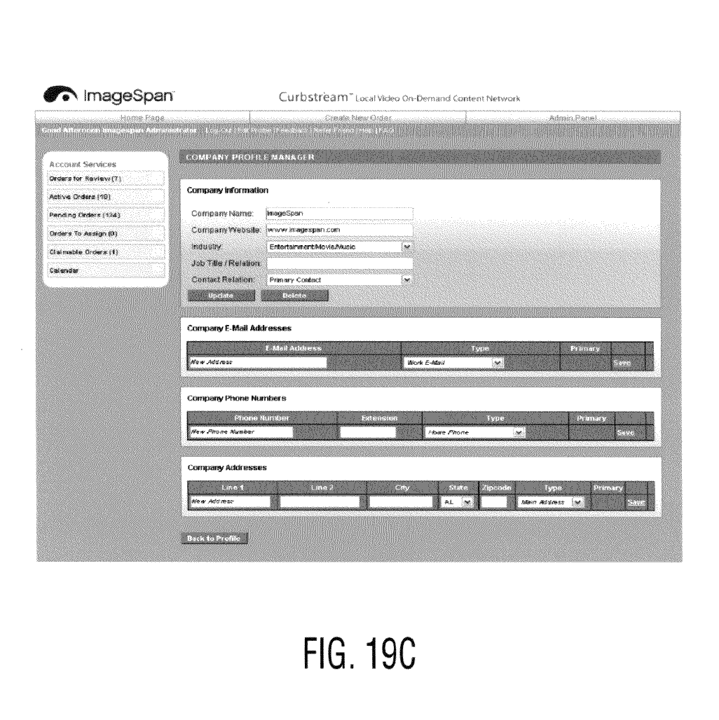

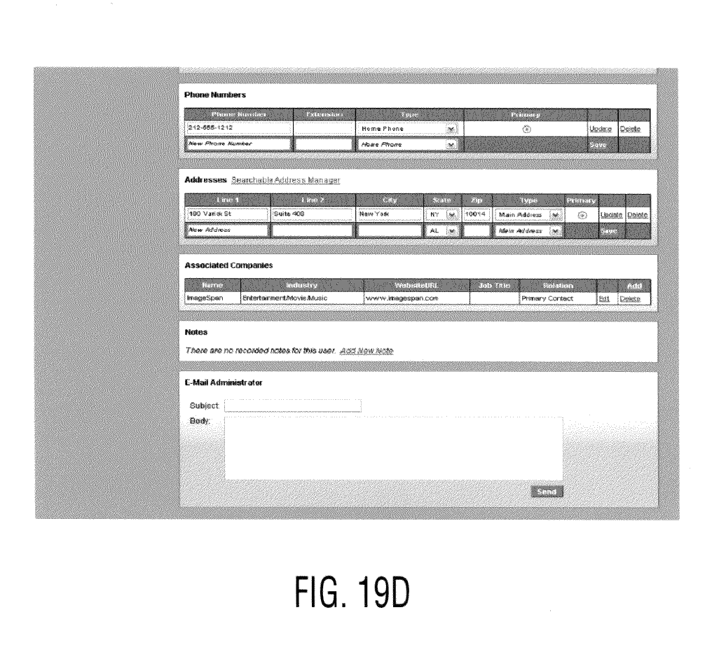

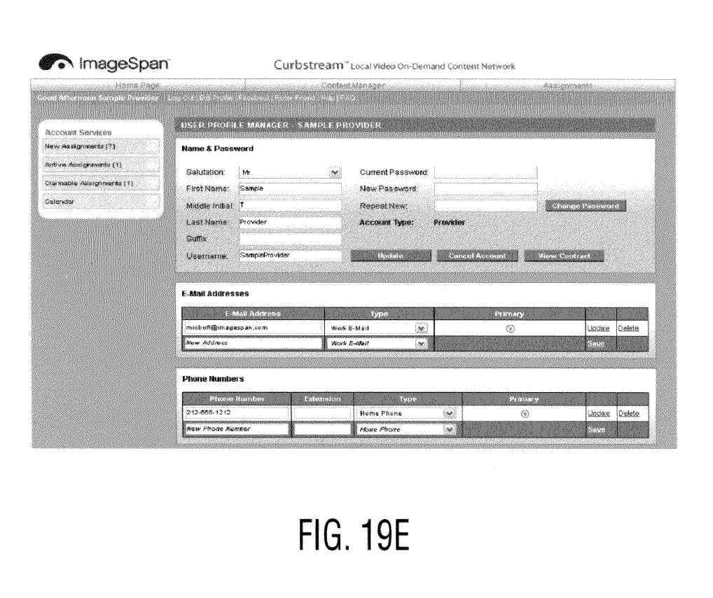

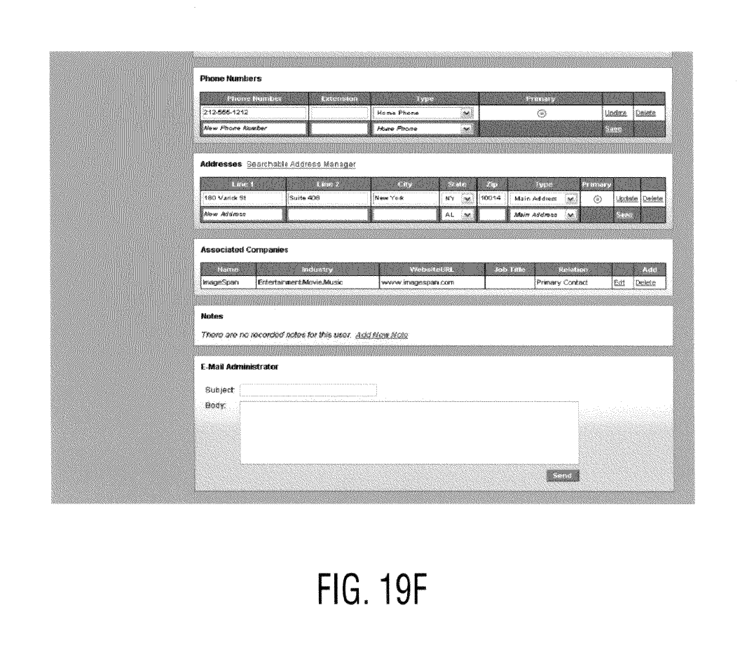

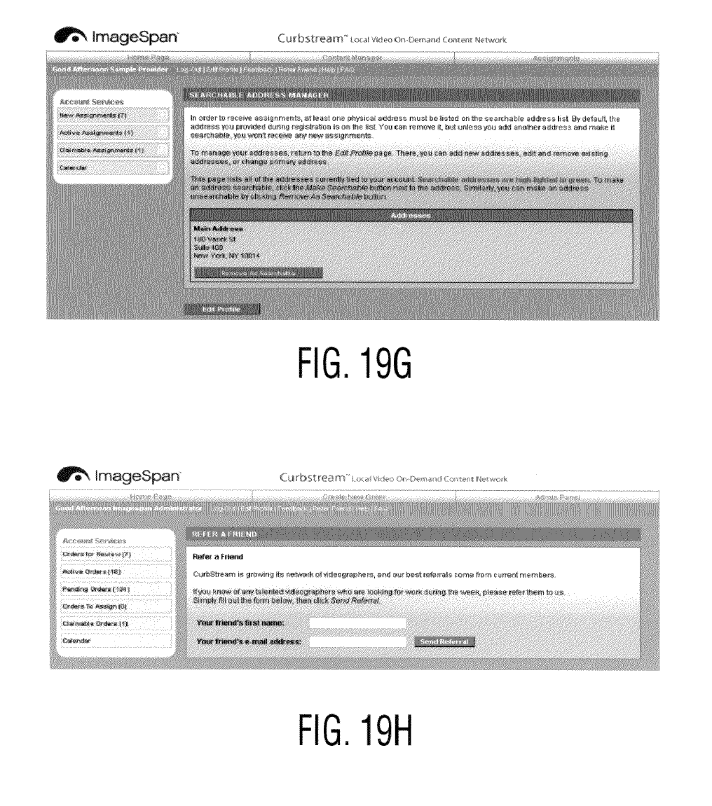

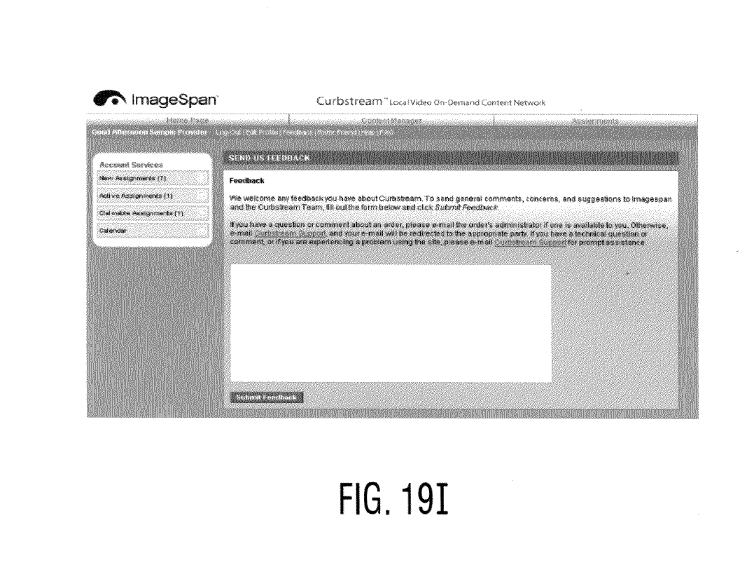

Referring to FIGS. 18 and 19A-19I, shown in FIG. 18 is a flowchart of processing steps according to the present invention, indicated generally at 610, for managing user accounts, addresses and profiles. In step 612, an administrator 614 (e.g., the administrator 26 of FIG. 1) is provided with a screen for selecting a user, as shown in FIG. 19A. This screen interfaces with a contact search system 616 and a contact management system 618. In step 620, the administrator searches or browses for a user. In step 622, when a user is located, the administrator is provided with the screen shown in FIG. 19B, and in steps 624 and 626, the administrator can edit user data and perform management functions in connection with a user account. For example, the administrator can set proxy logins, user passwords, deactivate users, view/edit contracts, provide notes, and e-mail users. The screen interfaces with an account manager subsystem 628. When account management is complete, account processing ends in step 630 and control passes to step 632. In step 632, the administrator can add or edit company information associated with a user. In step 634, the administrator is provided with the company profile management screens shown in FIGS. 19C-19D, wherein in step 636, the administrator can manage company information. Such information includes company address/contact information, e-mail addresses, phone numbers, etc.

In step 638, a user 640 (e.g., one or more of the content providers 12a-12c and/or the administrator 26 of FIG. 1) is provided with the profile pages shown in FIGS. 19E-19F which allow the user to manage addresses that are searchable by content providers. The profile pages interface with an account manager 642. In step 644, the profile pages allow the user to manage address information, as well as e-mail addresses, phone numbers, associated companies, notes, and administrator e-mails. In step 648, the user is provided with the searchable address manager screen shown in FIG. 19G, wherein in step 650 the user can choose addresses that are searchable by content providers. Also, a friend referral screen (see FIG. 19H) and a feedback screen (see FIG. 19I) could be provided to the user. The address manager screen (see FIG. 19G) interfaces with a provider selection and management subsystem 652. After management of addresses, processing completes in step 654.

In step 658, a user 660 (e.g., one or more of the content providers 20a-20c, one or more of the businesses 12a-12c, and/or the administrator 26 of FIG. 1) is provided with a screen (similar to the user account management screen shown in FIG. 19B) which allows the user to manage profile and/or account information. The screen interfaces with an account manager 662, and allows a user in steps 664-666 edit account preferences and profile data. In step 656, associated companies can be added or edited using the company information manager screens discussed above in connection with step 634. It is noted that the information processed by the steps of FIG. 18 can be stored in data stores 668, which could include a user/contact database 670, an administration database 672, a provider database 674, and a contract/licensing database 676.

Having thus described the invention in detail, it is to be understood that the foregoing description is not intended to limit the spirit or scope thereof. What is desired to be protected by Letters Patent is set forth in the appended claims.

What is claimed is:

1. A method for online content production, comprising:
providing a website in communication with a plurality of content requesters and a plurality of content providers;
allowing at least one of the plurality of content requesters to create an order for content using a plurality of user interface screens generated by the website;
receiving the order for content at the website;
selecting a content provider from the plurality of content providers;
transmitting the order to the content provider from the website;
allowing the content provider to create the content at a location specified in the order;
receiving the content from the content provider at the website;
allowing the content requestor to download the content from the website; and
receiving payment for the content from the content requester.

2. The method of claim 1, further comprising automatically reviewing the content at the central website to determine of the content complies with the order.

3. The method of claim 1, further comprising allowing an administrator to review the content provided by the content provider at the central website.

4. The method of claim 3, further comprising allowing the content requestor to review the content after the administrator has reviewed the content.

5. The method of claim 1, further comprising allowing the content requester to specify a desired length and format for the content in the order.

6. The method of claim 1, further comprising allowing the content requestor to specify production notes in the order to be followed by the content provider.

7. The method of claim 1, further comprising allowing the content requester to specify desired shots in the order to be included in the content.

8. The method of claim 1, further comprising distributing the payment to a plurality of recipients in accordance with a pre-defined royalty distribution.

9. The method of claim 1, further comprising providing a real-time indication of upload status as the content is received at the central website from the content provider.

10. A method for online content production, comprising:
providing a website in communication with a plurality of content requestors and a plurality of content providers;
allowing at least one of the plurality of content requesters to create an order at the website for content;
posting the order at the website for viewing by a plurality of content providers;
allowing at least one of the plurality of content providers to accept the order and create the content;
receiving the content from the content provider;
reviewing the content at the website to determine if the content complies with the order; and
allowing the content requestor to download the content from the website if the content complies with the order.

11. The method of claim 10, wherein the step of allowing at least one of the plurality of content requesters to create the order comprises allowing the content requester to specify a desired length and format for the content in the order.

12. The method of claim 10, wherein the step of allowing at least one of the plurality of content requesters to create the order comprises allowing the content requestor to specify production notes in the order to be followed by the content provider.

13. The method of claim 10, wherein the step of allowing at least one of the plurality of content requesters to create the order comprises allowing the content requestor to specify desired shots in the order to be included in the content.

14. The method of claim 10, further comprising reviewing credentials of the plurality of content providers before allowing one of the content providers to accept the order.

15. The method of claim 10, further comprising allowing an administrator to review the content provided by the content provider at the central website before the content requestor downloads the content.

16. The method of claim 15, further comprising allowing the content provider to create new content if the administrator determines that the content does not comply with the order.

17. The method of claim 15, further comprising assigning a new content provider to the order and allowing the new content provider to create new content if the administrator determines that the content does not comply with the order.

18. The method of claim 10, further comprising receiving payment for the content from the content requestor and distributing the payment to a plurality of recipients in accordance with a pre-defined royalty distribution.

19. The method of claim 10, further comprising determining a price for the content at the central website after receiving the content from the content provider.

20. A system for online content production, comprising:
a website in communication with a plurality of content requestors and a plurality of content providers;
a first set of user interface screens generated by the website for allowing at least one of the plurality of content requestors to create an order for content;
a database server in communication with the website for storing the order;
a second set of user interface screens generated by the website for allowing one of the plurality of content providers to accept the order, the content provider creating the content at a location specified in the order after accepting the order;
means for receiving the content from the content provider and for storing the content in the database server; and
means for allowing the content requestor to download the content from the website.

21. The system of claim 20, further comprising means for automatically reviewing the content provided by the content provider to determine if the content complies with the order.

22. The system of claim 20, further comprising means for allowing an administrator to review the content provided by the content provider to determine if the content complies with the order.

23. The system of claim 20, further comprising means for allowing the content requestor to review the content provided by the content provider to determine if the content complies with the order.

24. The system of claim 20, further comprising means for receiving payment from the content requestor for the content.

25. The system of claim 24, further comprising means for distributing the payment to a plurality of recipients in accordance with a pre-defined royalty distribution.
